(19) United States
(12) Patent Application Publication
(10) Pub. No.: US 2024/0292151 A1
(43) Pub. Date: Aug. 29, 2024

(54) DISTRIBUTED AUDIO PROCESSING FOR AUDIO DEVICES

(71) Applicant: Apple Inc., Cupertino, CA (US)

(72) Inventors: Sorin V. DUSAN, San Jose, CA (US); Andreas KOUTROUVELIS, Los Gatos, CA (US); Sungyub D. Yoo, Dublin, CA (US); Sarthak Khanal, San Jose, CA (US); Tony S. VERMA, San Francisco, CA (US)

(21) Appl. No.: 18/393,196

(22) Filed: Dec. 21, 2023

Related U.S. Application Data
(60) Provisional application No. 63/448,663, filed on Feb. 27, 2023.

(51) Int. Cl. H04R 3/00; G10L 21/0216; G10L 21/0264; H04R 1/10

(52) U.S. Cl. CPC H04R 3/005; G10L 21/0216; G10L 21/0264; H04R 1/1016; G10L 2021/02166; H04R 2420/07

(57) ABSTRACT

Implementations of the subject technology provide systems and methods for providing distributed audio processing for audio devices. Distributed audio processing may include encoding signals from multiple microphones and/or sensors, such as at a headphone or an earbud, and decoding and processing the signals on host, source, or companion device. Distributed audio processing may also include deactivating one or more digital signal processors and/or neural networks based on an operational mode of an audio device or based on a processing capability of a companion device.

### CROSS REFERENCE TO RELATED APPLICATIONS

This application claims the benefit of priority to U.S. Provisional Patent Application No. 63/448,663, entitled, “Environment-Dependent Audio Processing For Audio Devices”, filed on Feb. 27, 2023, the disclosure of which is hereby incorporated herein in its entirety.

### TECHNICAL FIELD

The present description relates generally to media output devices including, for example, to operations for distributed audio processing for audio devices.

### BACKGROUND

Audio devices such as headphones and earbuds can include speakers for outputting sound to a user's ears, and microphones for capturing the sound of the user's voice.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example system architecture including various electronic devices that may implement the subject system in accordance with one or more implementations.

FIG. 2 illustrates an example of a physical environment in which a media output device receives various audio inputs in accordance with implementations of the subject technology.

FIG. 3 illustrates a schematic diagram illustrating a media output device in communication with a companion electronic device in accordance with implementations of the subject technology.

FIG. 4 illustrates a schematic diagram of an example data flow for environment-dependent audio processing in accordance with one or more implementations of the subject technology.

FIG. 5 illustrates a schematic diagram of another example data flow for environment-dependent audio processing at a companion device in accordance with one or more implementations of the subject technology.

FIG. 6 illustrates an example of detecting environmental conditions in accordance with implementations of the subject technology.

FIG. 7 illustrates an example of control signals that can be used to activate and deactivate one or more digital signal processors and/or one or more neural networks in accordance with implementations of the subject technology.

FIG. 8 illustrates a schematic diagram of another example data flow for audio processing at a companion device in accordance with one or more implementations of the subject technology.

FIG. 9 illustrates a flow diagram for an example process for environment-based audio processing at an audio device in accordance with implementations of the subject technology.

FIG. 10 illustrates a flow diagram for an example process for environment-dependent audio processing at a companion device of an audio device in accordance with implementations of the subject technology.

FIG. 11 illustrates a flow diagram for an example process for audio processing at an audio device in accordance with implementations of the subject technology.

FIG. 12 illustrates a flow diagram for an example process for audio processing at a companion device of an audio device in accordance with implementations of the subject technology.

FIG. 13 illustrates a flow diagram for another example process for audio processing at a companion device in accordance with implementations of the subject technology.

FIG. 14 illustrates a flow diagram for an example process for audio processing at an earbud in accordance with implementations of the subject technology.

FIG. 15 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Digital signal processors and/or neural networks can be used in audio processing, such as processing of audio inputs received by one or more microphones of an audio device. As examples, digital signal processors and/or neural networks can be provided for speech enhancement (e.g., speech separation and/or noise reduction), audio source separation, voice detection, voice isolation, de-reverberation, beamforming, wind noise suppression, and/or other audio processing.

Aspects of the disclosure may provide selective activation and/or deactivation of digital signal processors (DSPs) and/or neural networks for audio signals, based on environmental conditions. This can be particularly beneficial, for example, for battery-powered devices such as earbuds or other wearable devices.

As an example, wind noise processing may be switched off when an indoor environment or a lack of wind is detected by an audio device. As another example, de-reverberation processing can be switched off when an outdoor environment or other low reverb environment is detected. As another example, an audio device, such as an earbud, may be operated in a voice-enhancement mode (e.g., for isolating a user's voice for telephony and/or audio/video conferencing, or for enhancing a voice of a speaker in front of the user to aid the user in hearing the speaker). A voice-enhancement mode may include a beamforming operation using multiple microphones, source separation and/or voice isolation operations, de-noising operations, and/or other audio signal processing operations. However, these voice-enhancement processing operations can be resource-intensive (e.g., may consume relatively large amounts of processing, memory, and/or power resources). Accordingly, the ability to switch off components of voice-enhancement processing operations and/or switch off the voice-enhancement mode when no speaker is detected, can be beneficial (e.g., to extend the battery life of a battery-operated device).

In one or more implementations, environmental condition detecting can be performed on the same device on which the DSPs and/or neural networks are implemented. In one or more other implementations, an environmental condition indicator can be generated at a first device (e.g., an earbud) and transmitted to a second device (e.g., a smartphone, smart watch, tablet device, laptop, etc. that is communicatively connected to the first device) for activation/deactivation of a DSP or neural network at the second device.

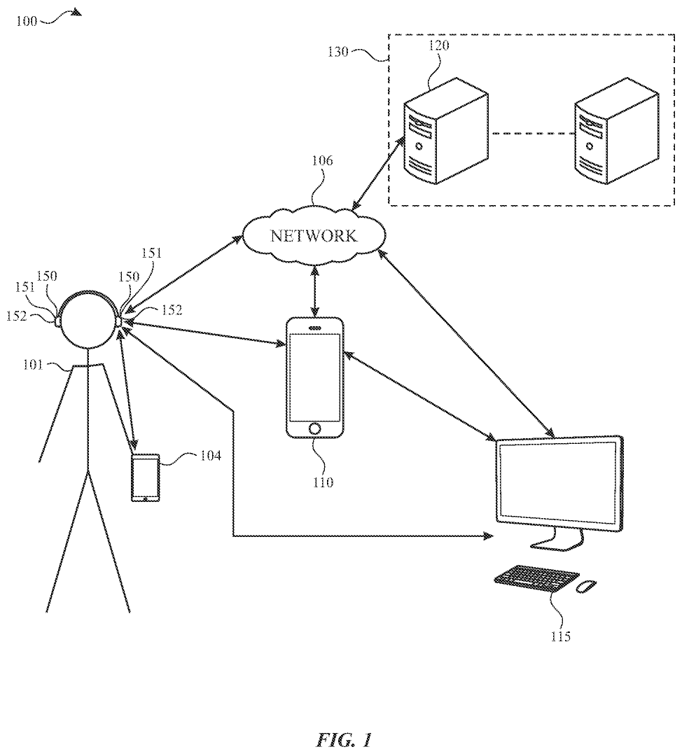

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes a media output device 150, an electronic device 104 (e.g., a handheld electronic device such as a smartphone or a tablet), an electronic device 110, an electronic device 115, and a server 120 communicatively coupled by a network 106 (e.g., a local or wide area network). For explanatory purposes, the system architecture 100 is illustrated in FIG. 1 as including the media output device 150, the electronic device 104, the electronic device 110, the electronic device 115, and the server 120; however, the system architecture 100 may include any number of electronic and/or audio devices and any number of servers or a data center including multiple servers.

The media output device 150 may be implemented as an audio device such as a smart speaker, headphones (e.g., a pair of speakers mounted in speaker housings that are coupled together by a headband), or an earbud (e.g., an earbud of a pair of earbuds each having a speaker disposed in a housing that conforms to a portion of the user's ear) configured to be worn by a user (also referred to as a wearer when the audio device is worn by the user), or may be implemented as any other device capable of outputting audio, video and/or other types of media (e.g., and configured to be worn by a user). Each media output device 150 may include one or more speakers such as speaker 151 configured to project sound into an ear of the user 101, and one or more microphones such as microphone 152 configured to receive audio input such as external noise input and/or external voice inputs. In one or more implementations, the media output device 150 may include multiple microphones 152 that can be co-operated to form a beamforming microphone array for obtaining sound preferentially from a particular direction and/or location.

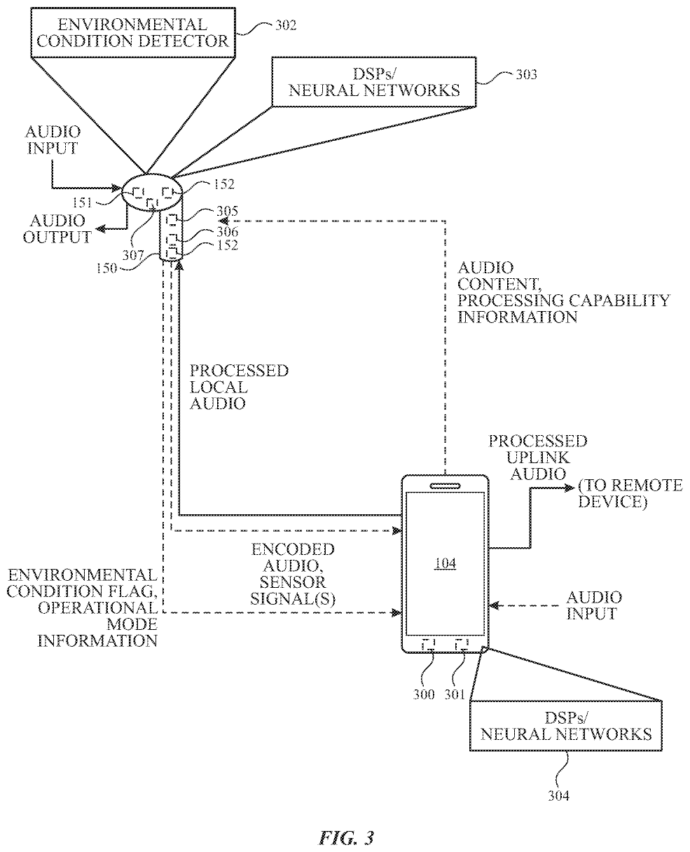

In one or more implementations, the media output device 150 may include display components for displaying video or other media to a user. Although not visible in FIG. 1 (see, e.g., FIG. 3), each media output device may include processing circuitry (e.g., including memory and/or one or more processors, such as a central processing unit and/or one or more digital signal processors (DSPs)) and communications circuitry (e.g., one or more antennas, etc.) for receiving and/or processing audio content from one or more of the electronic device 104, the electronic device 110, the electronic device 115, and/or the server 120. The processing circuitry of the media output device 150 or another device may operate one or more speakers, such as the speaker 151, to generate the sound. The memory may store one or more machine learning models implemented as neural networks and trained for one or more audio processing operations for the media output device 150.

The media output device 150 may include communications circuitry for communications (e.g., directly or via network 106) with the electronic device 104, the electronic device 110, the electronic device 115, and/or the server 120, the communications circuitry including, for example, one or more wireless interfaces, such as WLAN radios, cellular radios, Bluetooth radios, Zigbee radios, near field communication (NFC) radios, and/or other wireless radios. The electronic device 104, the electronic device 110, an electronic device 115, and/or the server 120 may include communications circuitry for communications (e.g., directly or via network 106) with media output device 150 and/or with the others of the electronic device 104, the electronic device 110, the electronic device 115, and/or the server 120, the communications circuitry including, for example, one or more wireless interfaces, such as WLAN radios, cellular radios, Bluetooth radios, Zigbee radios, near field communication (NFC) radios, and/or other wireless radios. The media output device may include a power sources such as a battery and/or a wired or wireless power source.

The media output device 150 may be communicatively coupled to a companion device such as the electronic device 104, the electronic device 110 and/or the electronic device 115 in some use cases. Such a companion device may, in general, include more computing resources (e.g., memory and/or processing resources) and/or available power in comparison with the media output device 150. In an example, media output device 150 may operate in various modes. For instance, the media output device 150 can operate in various modes of operations, such as a transparent mode of operation in which audio content (e.g., from electronic device 104) is played without removing or suppressing at least portions of an external audio input to the media output device, or a noise-cancelling mode of operation in which the audio content is played while removing or cancelling all external audio input (e.g., by filtering out external audio input and/or by generating an out-of-phase noise cancelling signal to cancel out the audio input) with the media output device 150. In the transparent mode operation and/or other modes of operation such as a voice enhancement mode of operation, one or more DSPs and/or neural networks of the media output device may perform source separation operations on incoming external audio input and may remove, cancel, suppress, and/or enhance various components of the separated incoming external audio input. In the noise-cancelling operation, one or more DSPs and/or neural networks of the media output device may perform source separation operations on the incoming external audio input to suppress, cancel, or remove all of the incoming external audio input from the sound that enters the user's ear.

The media output device 150 may also operate in one or more other modes of operation, such as a call/conference mode in which one or more DSPs and/or neural networks separate the voice of the user of the media output device 150 from other sounds in an audio input for transmission to another device (e.g., a remote device participating in a call, an audio conference, and/or a video conference with the user 101), or a speaker enhancement or hearing aid mode of operation in which one or more DSPs and/or neural networks separate the voice of a speaker other than the user of the media output device (or another predetermined sound such as an alarm, a cry of a baby or a pet, etc.) from other sounds in the audio input and the speaker(s) 151 of the media output device 150 are used to output the voice of the speaker (or the other predetermined sound) to the ear(s) of the user 101.

Source separation operations, voice isolation operations, de-noising operations, de-reverberation operations, and/or other audio processing operations may consume processing, memory, and/or power resources that may be limited in a device such as the media output device 150 (e.g., a battery powered device). Accordingly, in one or more use cases, it can be inefficient to continuously run these audio processing operations. In one or more implementations, the media output device 150 may determine one or more environmental conditions in the physical environment of the media output device 150, and may activate and/or deactivate one or more digital signal processors and/or one or more neural networks based on the environmental condition. For example, the memory of media output device 150 may store one or more machine learning models (referred to herein as lightweight classification models or classification models) for locally detecting an environmental condition.

Media output device 150 may also include one or more sensors such as touch sensors and/or force sensors for receiving user input. For example, a user/wearer of media output device 150 may tap a touch sensor or pinch the force sensor briefly to control the audio content being played, to control volume of the playback, and/or to switch between modes of operation. In one or more implementations, the user may hold down the force sensor while the media output device is operated in the noise-cancelling mode of operation to temporarily switch to the transparent mode of operation until the force sensor is released. As discussed in further detail hereinafter, media output device 150 may include one or more motion sensors, such as accelerometers, that are capable of detecting vibrations of the media output device 150 (e.g., due to the voice of a user wearing the media output device 150).

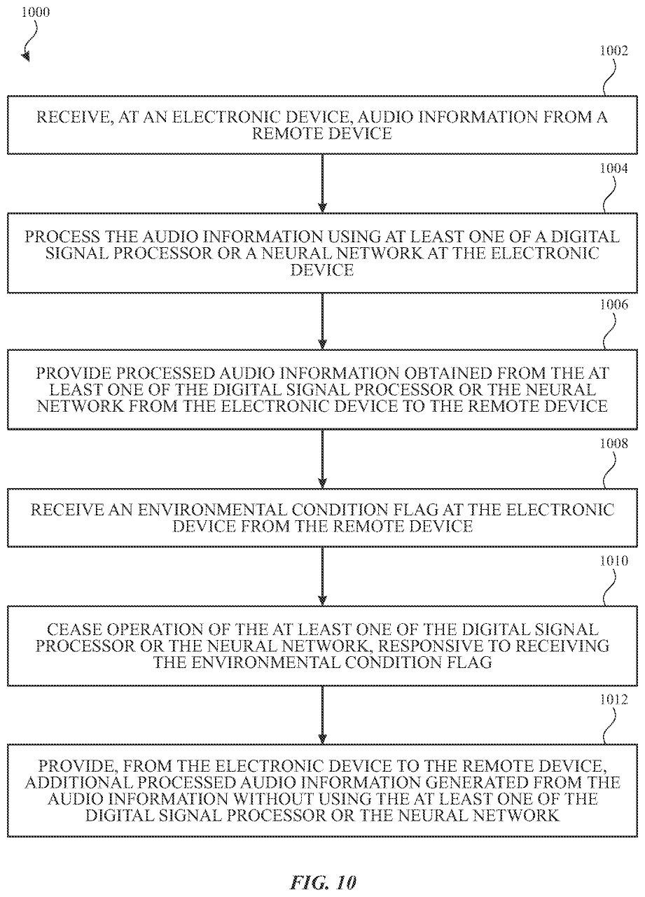

The electronic device 104 may be, for example, a smartphone, a portable computing device such as a laptop computer, a peripheral device (e.g., a digital camera, headphones, another audio device, or another media output device), a tablet device, a wearable device such as a smart watch, a smart band, and the like, any other appropriate device that includes, for example, processing circuitry and/or communications circuitry for providing audio content to media output device(s) 150. In FIG. 1, by way of example, the electronic device 104 is depicted as a mobile smartphone device with a touchscreen. In one or more implementations, the electronic device 104 and/or the media output device 150 may be, and/or may include all or part of, the electronic device discussed below with respect to the electronic system discussed below with respect to FIG. 10.

The electronic device 115 may be, for example, desktop computer, a portable computing device such as a laptop computer, a smartphone, a peripheral device (e.g., a digital camera, headphones, another audio device, or another media output device), a tablet device, a wearable device such as a watch, a band, and the like. In FIG. 1, by way of example, the electronic device 115 is depicted as a desktop computer. The electronic device 115 may be, and/or may include all or part of, the electronic system discussed below with respect to FIG. 10.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files for computer-generated reality environments. In an implementation, the server 120 may function as a cloud storage server.

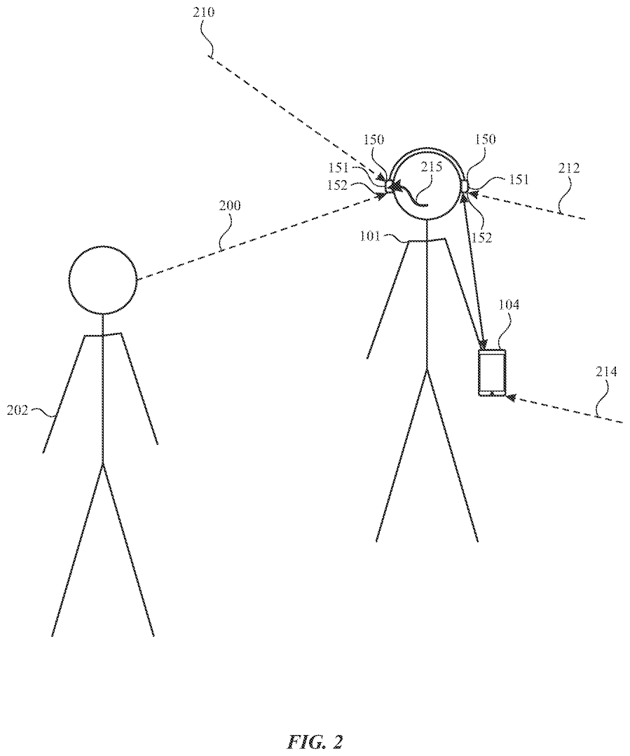

FIG. 2 illustrates a physical environment in which a user 101 is wearing one or more media output devices 150. In an example use case, the one or more media output devices 150 may receive and play audio content, from electronic device 104, using speaker(s) 151. The audio content may include media content (e.g., music, podcasts, an audio track accompanying video content, or any other audio media content) and/or voice content corresponding to the voice(s) of one or more remote users of one or more remote devices (e.g., during a telephone call, an audio conference, a video conference, a gaming session, or other collaborative or group communication session).

In the example of FIG. 2, various audio inputs are received by one or more microphones 152 of one or more media output devices 150. For example, FIG. 2 illustrates an audio input 200 corresponding to a voice input from a person 202 (e.g., a speaker) other than the user 101 of the media output device 150 that may be received by the microphone(s) 152 of media output device 150 (e.g., when the person 202 speaks to the user 101). As shown, an audio input 215 may also be received at the media output device(s) 150. For example, the audio input 215 may be a voice of the user 101 that is wearing the media output device 150. The audio input 215 may be received by the microphone(s) 152 of the media output device 150 (e.g., through the air and/or internally through the head of the user 101). The audio input 215 may also be received (e.g., internally through the head of the user 101, such as via bone conduction) using one or more motion sensors (e.g., accelerometers) of the media output device 150 in some implementations.

FIG. 2 also illustrates how other audio inputs, such as audio input 210 and audio input 212 may be received by one or more microphones 152 of one or more media output devices 150 from the physical environment of the user 101 and the media output device(s) 150. In various operational scenarios, audio input 210 and audio input 212 may correspond to audio inputs from the same noise source, such as ambient noise from the environment (e.g., ambient noise from a vehicle, such as a car, a bus, or an airplane when the user 101 is in or near the vehicle). In other operational scenarios, the audio input 210 and the audio input 212 may be different audio inputs. For example, the audio input 210 may be a desired audio input (e.g., a siren, an announcement, a voice of a desired speaker, or a predefined sound identified by the user 101) that the user 101 desires to have transmitted via the media output device 150 to the user's ear, and the audio input 212 may be an undesired audio input (e.g., noise from an open window, wind noise, crowd noise, and/or other noise sources).

In various operational scenarios in which the user 101 is wearing two media output devices 150 (e.g., implemented as a pair of earbuds), any or all of audio inputs 200, 210, 215, and/or 212 can be received by only one of the two media output devices, equally by both of the media output devices, or at different loudness levels by the two different media output devices. For example, when two media output devices 150 (e.g., a pair of earbuds) are worn in the two ears of a user, the two media output devices are separated by a distance (e.g., the width of the user's head) that can be known or estimated. In one or more implementations, the two media output devices 150 can determine the distance and/or the angular position for the source of each of one or more of the external audio inputs (e.g., the distance and/or angular position of the source of audio input 200 corresponding to the location of the person 202) relative to the locations of the media output devices. In one or more implementations, one or both of the media output device(s) 150 may perform beamforming operations using multiple microphone(s) 152, and/or may perform source separation operations, voice isolation operations, de-noising operations, and/or other audio processing operations to variously enhance, isolate, suppress, or remove, the audio input 200 from the person 202, the audio input 210, the audio input 212, and/or the voice of the user 101 in the microphone signals generated by the microphone(s) 152 in response to these audio inputs.

However, because less than all of the audio input 200, the audio input 210, the audio input 215, and the audio input 212 may be present at any given time, and/or other audio inputs may be present, the media output devices(s) 150 may activate and/or deactivate one or more DSPs and/or one or more neural networks, based on a detection of one or more environmental conditions in the physical environment of the media output device(s), based on an operational mode of the media output device 150, and/or based on one or more processing capabilities of a companion device, such as the electronic device 104.

In one or more implementations, the media output device(s) 150 may capture the audio input 200, the audio input 210, the audio input 212, the audio input 215, and/or other audio inputs, and provide audio information (e.g., encoded audio) and/or sensor signals corresponding to the audio inputs to a companion device, such as the electronic device 104, for audio processing at the companion device. In one or more implementations, the media output device(s) 150 may determine an environmental condition and provide environmental condition information (e.g., an environmental condition indicator or environmental condition flag) to the companion device for activation and/or deactivation of one or more DSPs and/or one or more neural networks at the companion device based on the environmental condition information. In one or more implementations, the media output device 150 may provide sensor signals, such as accelerometer signals, to the companion device, such as for use in voice detection and/or enhancement at the companion device. In one or more implementations, the media output device 150 may provide operational mode information for the media output device 150 to the companion device for processing of the audio signals and/or sensor signals according to the operational mode (e.g., for activation and/or deactivation of one or more DSPs and/or one or more neural networks at the companion device based on the operational mode). As illustrated in FIG. 2, in one or more implementations, additional audio input such as audio input 214 may also be received directly at a companion device such as electronic device 104. In one or more implementations, audio input 214 may be combined with audio information received from the media output device(s) for audio processing using activated DSPs and/or neural networks.

In one or more implementations, the media output device(s) 150 and/or the electronic device 104 may determine, based on an environmental condition detection, that a user desires to enhance speech (e.g., the user's own voice, and/or speech originating within a range of interest such as a distance range or an angular range of interest), to remove undesired noise without distortion to sound content within the range of interest, to remove undesired noise and preserve potential content of interest from all directions and/or distances, to remove all but salient and/or nearby sounds, and/or to cancel all external audio input (e.g., from all distances and/or angular positions), and may activate and/or deactivate one or more DSPs and/or one or more neural networks to achieve these goals without performing audio processing operations that do not serve these goals.

FIG. 3 is a schematic diagram that illustrates various aspects and/or operations of a media output device 150 and an electronic device 104 that may be used to provide audio processing (e.g., environment-based, mode-based, and/or capability-based audio processing) for audio devices, according to aspects of the disclosure. As illustrated in FIG. 3, media output device 150 may include one or more speakers 151, one or more microphones 152 (e.g., multiple microphones, such as a top microphone and a bottom microphone), memory 305, and processing circuitry 306. As shown, each media output device 150 may also include one more motion sensors 307. For example, the motion sensor 307 may be or include an accelerometer or other vibration sensor or inertial sensor. The accelerometer may be used to determine an orientation and/or overall motion of the media output device 150, and/or may be used to capture an accelerometer-based audio signal. For example, a vibration sensor, such as an accelerometer (e.g., motion sensor 307) may generate sensor signals that are affected by vibrations of the media output device 150 that are caused by acoustic vibrations received directly through the head of a user, such as via bone conduction (e.g., when the user 101 speaks while wearing the media output device 150). Such a sensor signal may be substantially immune to ambient noises and/or wind noise that may be picked up by the microphone(s) 152. In one or more implementations, these sensor signals may be processed, along with the audio signals from the microphone(s) 152, such as to enhance speech detection, speech enhancement, and/or audio quality, including in noisy and/or windy conditions.

As shown in FIG. 3, an audio device such as media output device 150 may receive an audio input (e.g., using one or more microphones 152). The audio input may include one or more audio components, such as one or more noise components, voice components, or the like. For example, the audio input of FIG. 3 may include the audio input 200, the audio input 210, the audio input 215, and/or the audio input 212 of FIG. 2, along with audio input generated by any other noise or sound sources in the environment of the media output device 150.

The processing circuitry 306 may operate the speaker 151 to generate an audio output including audio content received from the electronic device 104, and/to pass-through content including some or all of the audio input received at the microphone(s) 152 from the external environment. In one or more implementations, the processing circuitry 306 may include one or more DSPs that remove, suppress, and/or enhance various portions of an audio input before those portions pass through to the user's ear as audio output. In one or more implementations, the memory 305 may store, and the processing circuitry 306 may execute, one or more neural networks that are trained to remove, suppress, and/or enhance various portions of an audio input before those portions pass through to the user's ear as audio output.

As shown in FIG. 3, the media output device 150 may include an environmental condition detector 302. The environmental condition detector 302 may be implemented as a rules-based process and/or a neural network trained to identify one or more environmental conditions in the physical environment of the media output device 150. For example, the environmental condition detector 302 may be implemented as a lightweight classification model trained to detect one or more predefined environmental conditions.

As shown, the media output device 150 may also include one or more DSPs and/or neural networks 303. DSPs of the DSPs and/or neural networks 303 may be implemented as part of the processing circuitry 306. Neural networks of the DSPs and/or neural networks 303 may be stored in memory 305 for execution by one or more other processors of the processing circuitry 306. DSPs and/or neural networks 303 may form or be part of an audio processing pipeline that processes the audio inputs received by the microphone(s) 152 to generate processed audio locally at the media output device 150. The processed audio that is generated locally at the media output device 150 (e.g., by the DSPs and/or neural networks 303) may be output from the speaker(s) 151 as audio output, and/or may be provided (e.g., as encoded audio) to the electronic device 104 (e.g., for transmission, such as an uplink transmission, to one or more remote devices). As discussed in further detail hereinafter, the media output device 150 may activate or deactivate one or more of the DSPs and/or neural networks 303 based on an output of the environmental condition detector 302, based on an operational mode of the media output device 150, and/or based on one or more capabilities of a companion device, such as the electronic device 104.

As shown in FIG. 3, the electronic device 104 may include memory 300 and processing circuitry 301. In one or more use cases, the processing circuitry 301 may provide the audio content (e.g., music, podcasts, downlink audio, or other content) to the media output device 150 for output by the speaker(s) 151. The audio content that is provided by the electronic device 104 to the media output device 150 may include audio content stored at the electronic device 104, audio content obtained by the electronic device 104 from a remote source (e.g., a remote device or a remote server), and/or audio content generated at the electronic device 104 based on encoded audio received from the media output device 150.

For example, in one or more implementations, the electronic device 104 may include one or more DSPs and/or neural networks 304. DSPs of the DSPs and/or neural networks 304 may be implemented as part of the processing circuitry 301. Neural networks of the DSPs and/or neural networks 304 may be stored in memory 300 for execution by one or more other processors of the processing circuitry 306.

In these implementations in which the electronic device 104 includes DSPs and/or neural networks 304, the media output device 150 may receive the audio input with the microphone(s) 152 and/or the motion sensor(s) 307, encode some or all of the audio input, and provide the encoded (e.g., unprocessed or partially processed) audio to the electronic device 104. As shown, in one or more implementations, the media output device 150 may also encode one or more sensor signals from the motion sensor(s) 307 as part of, or along with, the encoded audio, and provide the encoded sensor signals to the electronic device 104. The media output device 150 may also process the audio input using the environmental condition detector 302 to generate an environmental condition indicator (e.g., an environmental condition flag), and provide the environmental condition indicator to the electronic device 104 along with the encoded audio. For example, the environmental condition indicator may indicate one or more environmental conditions identified by the environmental condition detector 302. The electronic device 104 may activate and/or deactivate one or more of the DSPs and/or neural networks 304 based on the environmental condition indicator.

In one or more implementations, the media output device 150 may be operable in various operational modes. As examples, the operational modes may include a media output mode (e.g., for outputting audio content such as music, podcasts, etc.), a noise cancellation mode for using the speaker 151 to cancel some or all of the ambient noise in the environment of the media output device 150, a pass-through or transparent mode, a telephony mode, and/or a hearing assistance mode, such as speech enhancement mode. For example, a hearing assistance mode and/or a speech enhancement mode may be configured to enhance speech (e.g., by the user 101 of the media output device or another person 202) in the environment, for output by the speaker 151 (or in an uplink signal from the electronic device 104 to a remote device, such as during a telephone call or audio or video conference). As shown, the media output device 150 may, in some implementations, provide operational mode information that indicates the operational mode of the media output device 150 to the electronic device 104. The electronic device 104 may activate and/or deactivate one or more of the DSPs and/or neural networks 304 based on the operational mode information.

In one or more implementations, the electronic device 104 may provide processed local audio, processed by the active ones of the DSPs and/or neural networks 304, to the media output device 150 (e.g., for output by the speaker(s) 151) in one or more use cases, such as for a hearing assistance mode of operation. In one or more other use cases, processed uplink audio generated by the active ones of the DSPs and/or neural networks 304 may be provided to one or more remote devices (e.g., remote devices connected to a phone call, an audio conference, a video conference, or other group communication session with the electronic device 104). In one or more implementations, the electronic device 104 may also obtain direct audio input (e.g., using a microphone of the electronic device 104) and may process the direct audio input using the active ones of the DSPs and/or neural networks 304.

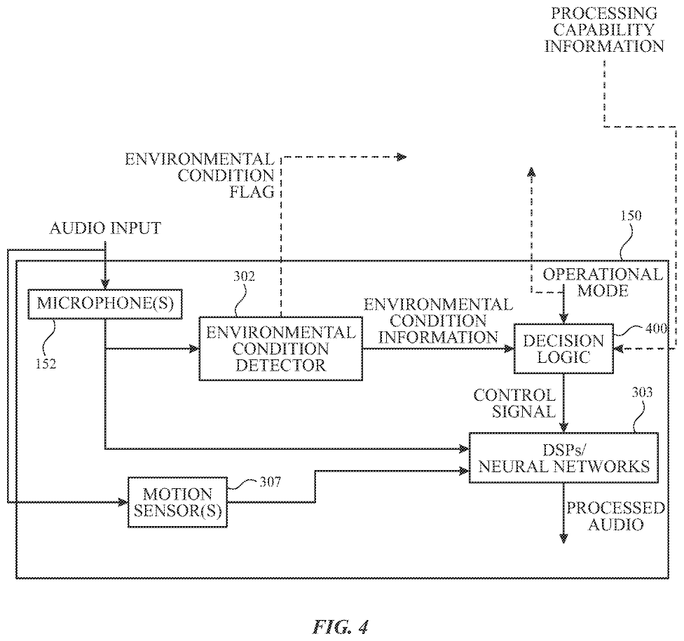

FIG. 4 is a schematic diagram illustrating a process for audio processing that may be performed at the media output device 150. As shown in FIG. 4, an audio input (e.g., the audio input 200, the audio input 210, and/or the audio input 212 of FIG. 2), received by the microphone(s) 152, may cause the microphone(s) 152 to generate an audio input signal that is provided (e.g., as microphone signals) to the environmental condition detector 302 and to the DSPs and/or neural networks 303. As shown, the motion sensor(s) 307 may generate, responsive to the audio input, one or more sensor signals that are also provided to the DSPs and/or neural networks 303. As shown, the environmental condition detector 302 may generate environmental condition information. The environmental condition information may identify one or more environmental conditions detected, by the environmental condition detector 302, in the physical environment of the media output device 150, as discussed in further detail hereinafter.

In the example of FIG. 4, the environmental condition information is provided to decision logic 400. Decision logic 400 may generate, based on the environmental condition information, one or more control signals for activating and/or deactivating one or more of the DSPs and/or neural networks 303. As shown, operational mode information (e.g., indicating the operational mode of the media output device 150) may also be provided to the decision logic 400. Decision logic 400 may generate, based on the operational mode information, one or more control signals for activating and/or deactivating one or more of the DSPs and/or neural networks 303. As shown, processing capability information (e.g., indicating the processing capabilities of a companion device such as the electronic device 104) may also be provided to the decision logic 400 (e.g., from the companion device, such as from the electronic device 104). Decision logic 400 may generate, based on the processing capability information for the companion device (e.g., an indication of the DSPs and/or neural networks 304 that are available at the companion device), one or more control signals for activating and/or deactivating one or more of the DSPs and/or neural networks 303 at the media output device 150. For example, the decision logic 400 may generate control signals for deactivating one or more of the DSPs and/or neural networks 303 that are separately available for use at the companion device (e.g., for processing the audio input at the companion device).

In one or more implementations, decision logic 400 may generate one or more control signals for activating and/or deactivating one or more of the DSPs and/or neural networks 303 based on two or all of the environmental condition information, the operational mode information, and/or the processing capability information. For example, the decision logic 400 may identify a subset of the DSPs and/or neural networks 303 for processing the audio input for a particular operational mode of the media output device 150 and in a current environmental condition, and/or may identify a further subset of the subset of the DSPs and/or neural networks 303 that are available at a the companion device and that can be deactivated at the media output device 150 and instead used at the companion device as part of the processing of the audio input.

The audio input (e.g., the microphone signals generated by the microphone(s) 152 from the audio input and/or the sensor signals generated by the motion sensor(s) 307) may be processed by the active ones of the DSPs and/or neural networks 303 at any given time to generate processed audio for output by the speaker(s) 151 and/or to be provided to the electronic device 104. As shown in FIG. 4, the environmental condition detector 302 may also generate one or more environmental condition indicators that can be provided to one or more other devices (e.g., a companion device such as the electronic device 104) for activation and/or deactivation of one or more DSPs and/or neural networks at the other device(s). As shown, the media output device 150 may also, or alternatively, provide the operational mode information to one or more other devices (e.g., a companion device such as the electronic device 104) for use in activation and/or deactivation of one or more DSPs and/or neural networks at the other device(s).

In the example of FIG. 4, the environmental condition detector 302, the decision logic 400, and the DSPs and/or neural networks 303 are disposed at the same device (e.g., the media output device 150). In other examples, an environmental condition detector, decision logic, and DSPs and/or neural networks may be distributed across multiple devices.

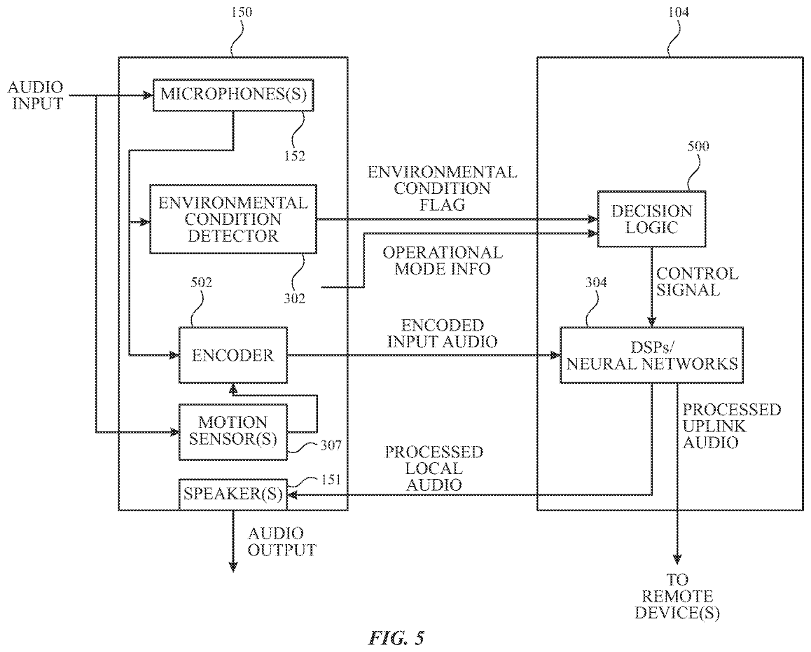

For example, FIG. 5 illustrates an implementation in which an audio input (e.g., the audio input 200, the audio input 210, the audio input 215, and/or the audio input 212 of FIG. 2), received by the microphone(s) 152 of the media output device 150, may cause the microphone(s) 152 to generate microphone signals that are provided to the environmental condition detector 302 at the media output device 150. As shown, some or all of the audio input (e.g., the audio input 215) may also be received by the motion sensor(s) 307, such as one or more accelerometers. In this example, the microphone signals and/or the sensor signals corresponding to the audio input may also be provided to an encoder 502 at the media output device 150. Encoded input audio (e.g., including encoded microphone signals and/or encoded sensor signals), generated by the encoder 502, may be provided to one or more DSPs and/or neural networks 304 disposed at another electronic device, such as the electronic device 104.

As shown in FIG. 5, the environmental condition detector 302 at the media output device 150 may generate one or more environmental condition indicators. The environmental condition indicators may identify one or more environmental conditions, detected by the environmental condition detector 302, in the physical environment of the media output device 150, as discussed in further detail hereinafter. In the example of FIG. 5, the environmental condition indicators are provided to decision logic 500 at the electronic device 104. As shown, operational mode information (e.g., an indication of a current operational mode of the media output device, such as a hearing assistance mode in which enhancement of external speech is prioritized) may also be provided to the decision logic 500 (e.g., by the environmental condition detector 302 or from another process at the media output device 150). Decision logic 500 may generate, based on the environmental condition indicator(s) and/or the operational mode information, one or more control signals for activating and/or deactivating one or more of the DSPs and/or neural networks 304 at the electronic device 104. As shown, the encoded audio input received from the media output device 150 may be (e.g., decoded and) processed by the active ones of the DSPs and/or neural networks 304 at the electronic device 104 at any given time, to generate processed local audio (e.g., an audio output including enhanced or suppressed sounds from the user of the media output device 150 and/or the environment around the media output device 150 and/or the electronic device 104) and/or processed uplink audio (e.g., including a voice of the user of the media output device 150 for uplink to a remote device). The processed local audio may be provided back to the media output device 150 for output by the speaker(s) 151. The processed uplink audio may be provided to one or more remote devices, such as in an uplink signal for a call, audio conference, video conference, or other communication session.

For example, if the media output device 150 is operating in an audio enhancement mode or a hearing assistance mode, the processed local audio may include audio content corresponding to a voice of a person (e.g., person 202 of FIG. 2), other than the user of the media output device 150, that is speaking to the user of the media output device 150. In this example, the processed local audio may be free of ambient noise that was present in the encoded input audio, and that was removed by the DSPs and or neural networks 304. As another example, if the media output device 150 is being used as an audio output device (e.g., a headphone or an earbud) for the electronic device 104, while the electronic device 104 is connected to a communication session with a remote electronic device (e.g., during a telephone call, an audio conferencing session, a video conferencing session, or other group communication session), the processed uplink audio may include audio content corresponding to the voice of the user of the media output device 150. In these illustrative examples, the processed uplink audio may be provided to a remote electronic device (e.g., electronic device 110 or electronic device 115), and/or some or all of the processed local audio may be provided back to the media output device 150 to be output by the speakers 151 (e.g., as self-voice feedback or hearing assistance audio for the user of the media output device 150). As another example, the processed audio (e.g., processed local audio and/or processed uplink audio) as generated by the DSPs and or neural networks 304, may include reverberation-removed audio in which reverberation effects on the audio input from the physical environment of the media output device 150 have been removed by the DSPs and or neural networks 304. In this example the processed local audio may be provided back to the media output device 150 for output from the speakers 151 as reverberation-removed audio output.

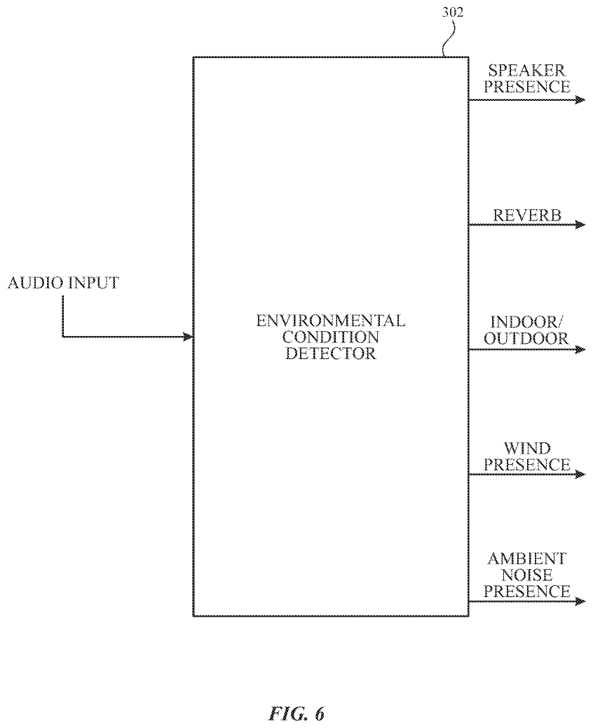

FIG. 6 illustrates an example environmental condition detector 302 in accordance with one or more implementations. In various implementations, the environmental condition detector 302 may be implemented as a rules-based process for detecting environmental conditions in audio input data, and/or may be implemented by one or more machine learning models (e.g., neural networks) that have been trained to detect and/or identify (e.g., classify) one or more environmental conditions responsive to receiving audio input.

As shown in FIG. 6, the environmental condition detector 302 may be configured to detect and/or identify, based on the audio input (e.g., the audio input obtained by the microphone(s) 152 of the media output device 150) environmental conditions such as a speaker presence, reverberation (reverb), an indoor/outdoor condition, a wind presence condition, and/or an ambient noise presence condition (as examples). For example, the speaker presence condition may indicate the presence of one or more speakers (e.g., people speaking) in the physical environment of the media output device 150, and/or a location, relative to the media output device, of the one or more speakers. In one or more implementations, the speaker presence condition can be detected by providing an audio input to a machine learning model (e.g., a neural network trained as a classifier) that has been trained by adjusting one or more weights and/or other parameters of the machine learning model based on a comparison of training output data (e.g., a speaker presence label indicating whether and/or where a speaker is present in the training audio input) with a training output of the machine learning model generated in response to a training audio input.

For example, the reverb condition may indicate the presence of reverberations in the physical environment of the media output device 150, and/or an amount or level of the reverberations in the physical environment. For example, the indoor/outdoor condition may indicate whether the media output device 150 is currently in an indoor environment or in an outdoor environment. In one or more implementations, the reverb condition can be detected by providing an audio input to a machine learning model (e.g., a neural network trained as a classifier) that has been trained by adjusting one or more weights and/or other parameters of the machine learning model based on a comparison of training output data (e.g., a reverb label indicating whether and/or how much reverberation is present in the training audio input) with a training output of the machine learning model generated in response to a training audio input.

For example, the indoor/outdoor condition may indicate whether the device receiving the audio input is an indoor environment (e.g., an environment at least partially enclosed by one or more walls, windows, doors, roofs, ceilings, and/or other structures that reflect sound) or an outdoor environment. In one or more implementations, the indoor/outdoor condition can be detected by providing an audio input to a machine learning model (e.g., a neural network trained as a classifier) that has been trained by adjusting one or more weights and/or other parameters of the machine learning model based on a comparison of training output data (e.g., an indoor/outdoor label indicating whether the training audio input was recorded indoors or outdoors) with a training output of the machine learning model generated in response to a training audio input.

For example, the wind presence condition may indicate whether wind is detected in the audio input, and/or an amount or level of the wind that is detected in the audio input. In one or more implementations, the speaker presence condition can be detected by providing an audio input to a machine learning model (e.g., a neural network trained as a classifier) that has been trained by adjusting one or more weights and/or other parameters of the machine learning model based on a comparison of training output data (e.g., a wind presence label indicating whether, how much, and/or a directionality of wind noise that is present in the training audio input) with a training output of the machine learning model generated in response to a training audio input.

For example, the ambient noise presence indicator may indicate whether ambient noise is detected in the audio input, an amount or level of the ambient noise, and or one or more additional details of the ambient noise. For example, in one or more implementations, the ambient noise presence indicator may indicate a type and/or a location of one or more ambient noise sources detected in the ambient noise in the audio input. In one or more implementations, the ambient noise presence condition can be detected by providing an audio input to a machine learning model (e.g., a neural network trained as a classifier) that has been trained by adjusting one or more weights and/or other parameters of the machine learning model based on a comparison of training output data (e.g., a wind noise presence label indicating whether, how much, a type, and/or a location of one or more sources of ambient noise that are present in the training audio input) with a training output of the machine learning model generated in response to a training audio input.

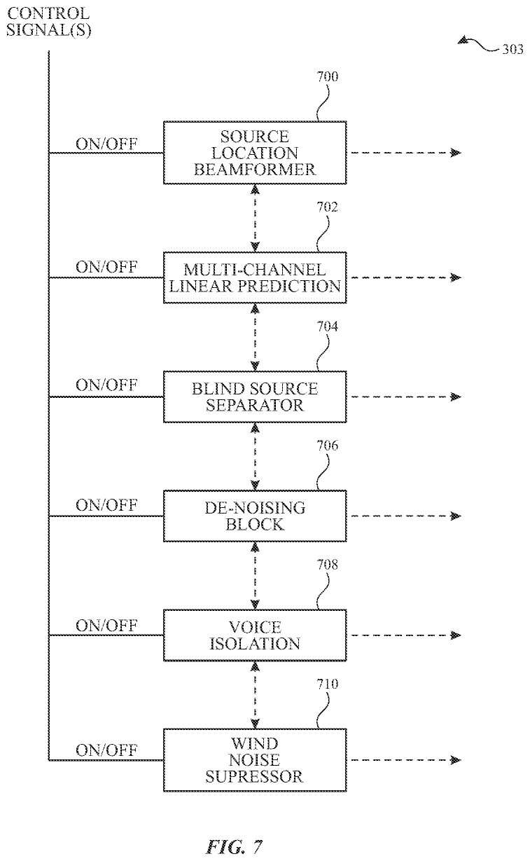

FIG. 7 illustrates how control signals (e.g., control signals generated by the decision logic 400 of FIG. 4 or the decision logic 500 of FIG. 5 based on environmental condition information, operational mode information, and/or companion device processing capability information) may be used to activate or deactivate one or more DSPs and/or neural networks, such as the DSPs and/or neural networks 303 of the media output device 150. As shown in FIG. 7, the DSPs and/or neural networks 303 may include, as examples, a source location beamformer 700, a multi-channel linear prediction block 702, a blind source separator 704, a de-noising block 706, a voice isolation block 708, a wind noise suppressor 710, and/or other audio processing blocks (e.g., time-to-frequency, frequency-to-time, equalization (EQ), automatic gain control (AGC), side channel (SC), multi-microphone wiener filtering, generalized sidelobe cancellation, etc.). Each of the source location beamformer 700, the multi-channel linear prediction block 702, the blind source separator 704, the de-noising block 706, the voice isolation block 708, the wind noise suppressor 710, and/or the other audio processing blocks can be implemented as a digital signal processor (DSP) or as a neural network.

As described herein, running all of the source location beamformer 700, the multi-channel linear prediction block 702, the blind source separator 704, the de-noising block 706, the voice isolation block 708, the wind noise suppressor 710, and/or the other audio processing blocks at all times may unnecessarily drain the resources of the media output device 150. In order, for example, to reduce the power and/or processing resources used by the audio processing operations, the control signals may be provided to switch on or off any or all of the source location beamformer 700, the multi-channel linear prediction block 702, the blind source separator 704, the de-noising block 706, the voice isolation block 708, the wind noise suppressor 710, and/or the other audio processing blocks at one or both of the media output device 150 and the electronic device 104, based on the environmental condition information generated by the environmental condition detector 302, based on the operational mode information for the media output device 150, and/or based on the processing capability information for the electronic device 104. In this way, environment-based, mode-based, and/or capability-based audio processing can be provided for electronic devices such as the media output device 150 (e.g., an audio device) and/or the electronic device 104 (e.g., a companion device for an audio device).

In one or more implementations, deactivating a DSP or a neural network may include switching off or ceasing operation of the DSP or the neural network. In one or more other implementations, deactivating a DSP or a neural network may include switching an audio processing path around the DSP or the neural network to bypass the DSP or the neural network (e.g., while continuing to operate the DSP or neural network outside of the audio processing pipeline that generates processed audio for output). In one or more other implementations, rather than switching off or bypassing an entire DSP or neural network based on a detected environmental condition, operational mode, and/or processing capability, the DSP or neural network may be operated in a course mode or low-power mode (e.g., by switching off and/or bypassing a portion of the DSP or neural network). In any of these implementations, switching off, ceasing operation, bypassing, and/or operating a DSP and/or neural network may modify the operation of a DSP and/or a neural network to reduce power consumption and/or computing resource usage by the DSP and/or the neural network based on one or more environmental conditions (e.g., when the environmental condition(s) indicate that running the DSP and/or neural network at full power may not be beneficial to the user experience), operational modes, and/or companion device processing capabilities.

As indicated in FIGS. 4 and 5 (and not explicitly shown in FIG. 7 to emphasize the control signals), audio input signals (e.g., microphone signals and/or sensor signals such as accelerometer signals) can be provided to any or all of the source location beamformer 700, the multi-channel linear prediction block 702, the blind source separator 704, the de-noising block 706, the voice isolation block 708, the wind noise suppressor 710, and/or the other audio processing blocks of the DSPs and/or neural networks 303. The dashed arrows in FIG. 7 indicate how the source location beamformer 700, the multi-channel linear prediction block 702, the blind source separator 704, the de-noising block 706, the voice isolation block 708, the wind noise suppressor 710, and/or the other audio processing blocks may operate independently to generate respective outputs and/or may be co-operated (e.g., by providing an output of any one of the source location beamformer 700, the multi-channel linear prediction block 702, the blind source separator 704, the de-noising block 706, the voice isolation block 708, the wind noise suppressor 710, and/or the other audio processing blocks as an input to any other one of the source location beamformer 700, the multi-channel linear prediction block 702, the blind source separator 704, the de-noising block 706, the voice isolation block 708, the wind noise suppressor 710, and/or the other audio processing blocks).

In one example use case, the multi-channel linear prediction block 702 may be used as a reverberation removal block and may be switched off or otherwise deactivated, by the control signals, when a low reverberation environment or an outdoor environment are indicated by the environmental condition information (e.g., the reverb indicator of FIG. 6) generated by the environmental condition detector 302. In another example use case, the voice isolation block 708 may be switched off or otherwise deactivated, by the control signals, when the environmental condition information (e.g., the speaker presence indicator of FIG. 6) indicates that no voices are detected in the audio input (e.g., for a predetermined amount of time). In another example use case, the voice isolation block 708 may be switched on or otherwise activated, by the control signals, when the media output device is in a hearing assistance mode, whether or not the environmental condition information (e.g., the speaker presence indicator of FIG. 6) indicates that voices are detected in the audio input (e.g., for a predetermined amount of time). As another example use case, the de-noising block 706 may be switched off or deactivated, by the control signals, when the environmental condition information (e.g., the ambient noise presence indicator of FIG. 6) indicates low levels of ambient noise in the audio input. As another example use case, the source location beamformer 700 may be switched off or otherwise deactivated when the environmental condition information (e.g., the speaker presence indicator and/or the ambient noise indicator of FIG. 6) indicates that no sources of sound are identified in the physical environment of the media output device (e.g., for a predetermined amount of time). In another example use case, the wind noise suppressor 710 may be switched off or otherwise deactivated when the environmental condition information (e.g., the wind presence indicator of FIG. 6) indicates that wind noise is not present (e.g., for a predetermined amount of time) in the audio input.

As discussed herein (e.g., in connection with FIG. 5), in one or more implementations, encoded input audio (e.g., including encoded microphone signals from one, two, three, four, or more than four microphones, and/or encoded sensor signals, such as accelerometer signals from one, two, three, four, or more than four accelerometers) may be provided from a media output device 150 (e.g., an earbud) to one or more DSPs and/or neural networks 304 disposed at another electronic device, such as the electronic device 104. In various implementations, one or more microphone signals and/or one or more sensor signals (e.g., accelerometer signals) may be wirelessly transmitted from a media output device 150 to a companion device, such as electronic device 104 (e.g., using Bluetooth, WiFi, or the like). In some implementations, the wireless protocol used to transmit the microphone signals and/or sensor signals may support transmission of any number of audio channels, including transmitting the each of the microphone signals and each of the sensor signals as its own audio channel. However, in some implementations, the number of audio channels that can be concurrently transmitted from a media output device may be limited (e.g., due to hardware limitations and/or bandwidth limitations), such as to a number of audio channels that is less than the number of microphone and/or sensor signals to be transmitted. For example, a transport mechanism, layer, and/or specification may be restricted to a particular number of audio channels (or channels). For example, transmitting using a Bluetooth connection may limit the number of audio channels to two audio channels, in some implementations. In one or more implementations, multiple audio-related signals (e.g., microphone signals, sensor signals, and/or the like) may be multiplexed for transmission over the limited number of channels.

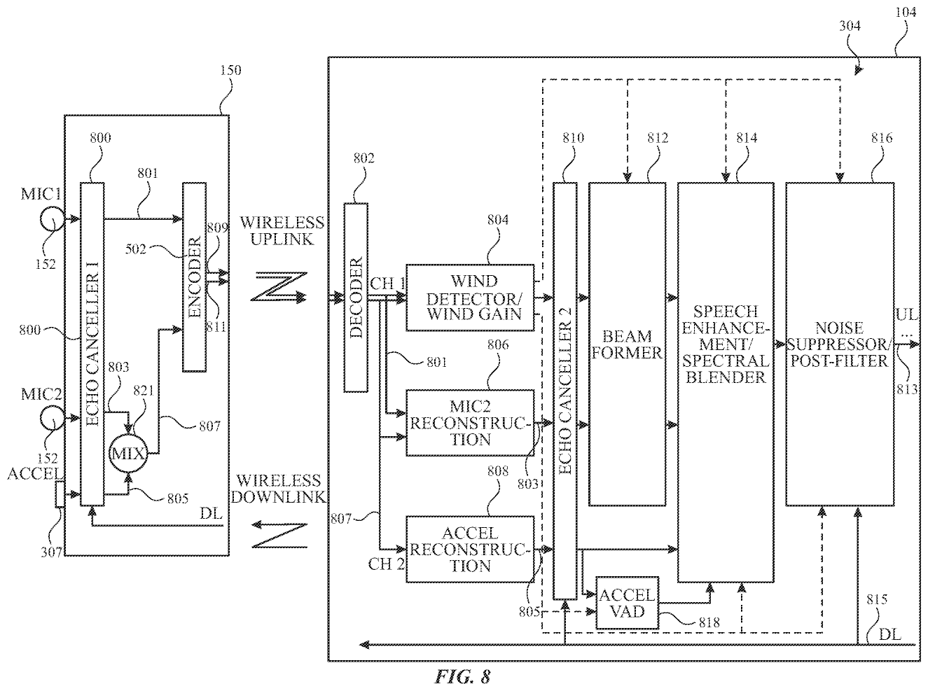

For example, FIG. 8 illustrates an exemplary implementation in which the media output device 150 includes two microphones 152 and a motion sensor 307 (e.g., an accelerometer, such as a voice accelerometer). In the example of FIG. 8, DSPs and/or neural networks 304 are shown in a configuration for generating and transmitting a voice of a user (e.g., of the media output device 150 and the electronic device 104) to a remote device (e.g., a remote device of a far-end user). As shown, a first one of the microphones 152 may generate a first microphone signal 801, a second one of the microphones 152 may generate a second microphone signal 803, and the motion sensor 307 may generate a sensor signal 805 (e.g., an accelerometer signal). As shown, the first microphone signal 801 may be provided to the encoder 502 for encoding and transmission to the electronic device 104 as a first audio channel 809 (e.g., Ch1). As shown, the media output device 150 may include a mixer 821 (e.g., a frequency domain mixer) that receives the second microphone signal 803 and the sensor signal 805. The mixer 821 may mix the second microphone signal 803 (e.g., a portion of the microphone signal from zero to Nyquist frequency minus an upper frequency threshold, such as a threshold of between seven hundred Hz and 1.5 kHz) and the sensor signal 805 (e.g., a portion of the sensor signal from zero to the upper frequency threshold), placed starting at the Nyquist frequency minus the upper frequency threshold, to form a mixed signal 807.

The mixed signal 807 (e.g., including, in the lower frequency part, at least a portion of the second microphone signal 803 and, in the higher frequency part, at least a portion of the accelerometer signal 805) may be provided to the encoder 502 for encoding and transmission, as a second audio channel 811 (e.g., Ch2), to the electronic device 104. For example, the media output device 150 may be limited to transmission of two audio channels in some implementations. In various implementations, the two audio channels can be wirelessly streamed individually or as stereo.

In this example, a decoder 802 at the electronic device 104 may decode the encoded first and second audio channels 809 and 811, to obtain the first microphone signal 801 and the mixed signal 807. As shown, the electronic device 104 may include a microphone reconstruction block 806 that reconstructs the second microphone signal 803 from the mixed signal 807 (e.g., based on pre-stored information about the mixing process performed by the mixer 821), and from the first microphone signal 801 included in the first audio channel 809. Thus, the second microphone signal 803 may be reconstructed in a first range between zero frequency and Nyquist frequency minus an upper frequency threshold from the mixed signal 807, and approximated in a second range between Nyquist frequency minus the upper frequency threshold and the Nyquist frequency from the same frequency range of the first microphone signal 801 included in the first audio channel 809. As shown, the electronic device 104 may also include an accelerometer reconstruction block 808 that reconstructs that sensor signal 805 from the mixed signal 807 (e.g., based on pre-stored information about the mixing process performed by the mixer 821). In one or more implementations, the accelerometer signal 805 may be reconstructed only in the band between zero frequency and the upper frequency threshold from the mixed signal 807 between Nyquist frequency minus the upper frequency threshold and the Nyquist frequency. As shown, the first microphone signal 801, the second microphone signal 803, and the sensor signal 805 may be provided to various DSPs and/or neural networks 304 at the electronic device 104. As discussed herein, DSPs and/or neural networks 304 may be activated and/or deactivated based on environmental condition information, operational mode information, and/or processing capability information. As shown, active ones of the DSPs and/or neural networks 304 may generate an output signal, such as processed audio 813, which may be provided to one or more remote devices as an uplink signal, and/or may be provided to the media output device 150 for output by a speaker 151 of the media output device 150 (e.g., so that the user of the media output device 150 can hear their own voice in an output by the speaker 151).

In the example of FIG. 8, the DSPs and/or neural networks 304 include a wind detector/wind gain block (e.g., an implementation of the wind noise suppressor 710 of FIG. 7), an echo canceler 810, a beam former 812 (e.g., an implementation of the source location beamformer 700 of FIG. 7), a speech enhancement/spectral blender (e.g., an implementation of the voice isolation block 708 of FIG. 7), a noise suppressor/post-filter 816 (e.g., an implementation of the de-noising block 706 of FIG. 7), and/or a voice activity detector (VAD) 818, such as an accelerometer-based VAD. The wind detector 804 and the beam former 812 may be set to process signals up to the Nyquist frequency minus an upper frequency threshold. In order, for example, to avoid spatial aliasing, the beam former 812 may replace its output between the Nyquist frequency minus the upper frequency threshold and the Nyquist frequency, with the corresponding frequency components of the first microphone signal 801. This encoding/decoding method placing the accelerometer (e.g., useful) frequency components in the higher spectra of one of the microphones is possible because, for a small distance between the microphones (e.g., as in wearable devices such as headsets, headphones, and/or earbuds) the very high frequencies of the beamformer may contain spatial aliases that can be replaced with the output of one of the microphones.

In this example, the first microphone signal 801 and the mixed signal 807 may be provided to the wind detector/wind gain block 804. The wind detector/wind gain block 804 may provide wind information to the VAD 818, the beam former 812, the speech enhancement/spectral blender 814, and/or the noise suppressor/post-filter 816. As shown, the echo canceller 810 may also receive the first microphone signal 801, the (e.g., reconstructed) second microphone signal 803, and the (e.g., reconstructed) sensor signal 805. The echo canceller 810 may provide an echo-cancelled first microphone signal and an echo-cancelled second microphone signal to the beam former 812 and may provide an echo-cancelled accelerometer signal to the VAD 818 and the speech enhancement/spectral blender 814 (e.g., including Blind Source Separation, a multi-microphone or multichannel Wiener Filter, a Generalized Sidelobe Canceller, a Deep Neural Network, etc.). As shown, based on the echo-cancelled first microphone signal, the echo-cancelled second microphone signal, the echo-cancelled accelerometer signal, the wind information, and an output from the VAD 818, the speech enhancement/spectral blender 814 may provide a speech-enhanced/spectral blended signal to the noise suppressor/post-filter 816, which may perform noise suppression and/or post filtering operations to generate the processed audio 813 based on the speech-enhanced/spectral blended signal and the wind information. The example of FIG. 8 may illustrate a set of the DSPs and/or neural networks 304 that may be used in a telephony or conferencing mode of operation, for the media output device 150. In one or more other use cases, and as discussed herein, some or all of the DSPs and/or neural networks 304 shown in FIG. 8 may be deactivated based on environmental condition information and/or based on another operational mode of the media output device 150, and/or one or more other DSPs and/or neural networks 304 may be activated based on another operational mode of the media output device 150.

In one or more implementations, the media output device 150 may also, or alternatively, include an echo canceller 800 that cancels an output of a speaker of the media output device that is received as part of the audio input to the microphone(s) 152 and/or the motion sensor 307), before the microphone signals and/or sensor signals are provided to the encoder 502 and/or the mixer 821. As shown, in one or more use cases, a downlink signal 815 from a remote device participating in a call or conference with the electronic device 104 may also be provided to the noise suppressor/post-filter 816, the echo canceller 810, and/or the echo canceller 800 (e.g., and also may be provided for output by a speaker of the media output device 150).

In the example of FIG. 8, the first audio channel 809 and the second audio channel 811 are transmitted by the media output device 150 having the microphones 152 and the motion sensor 307. As discussed herein the media output device 150 may be implemented as an earbud. In one or more implementations, each of two earbuds may individually transmit a first audio channel 809 and a second audio channel 811 as described in FIG. 8. In one or more other implementations, a second of two earbuds may transmit a first audio channel 809 and a second audio channel 811 to a companion device through a first (e.g., primary) one of the two earbuds.

Although two microphones 152 and one accelerometer 307 are shown in FIG. 8, it appreciated that, in one or more other implementations, the media output device 150 may include one or more additional microphones (e.g., more than two microphones) that generate one or more additional microphone signals, and/or one or more additional accelerometers (e.g., more than one accelerometer) that generate one or more additional accelerometer signals. In these other implementations, the one or more additional microphone signals and/or the one or more additional accelerometer signals may also be provided from the media output device 150 to the electronic device 104 for processing at the electronic device 104 (e.g., by the DSPs and/or neural networks 304) together with the first microphone signal 801, the second microphone signal 803, and the accelerometer signal 805. In various implementations, the one or more additional microphone signals and/or the one or more additional accelerometer signals may be transmitted from the media output device 150 over one or more additional channels, or some or all of the one or more additional microphone signals and/or the one or more additional accelerometer signals may be combined (e.g., frequency-domain mixed) with one or more of the first microphone signal 801, the second microphone signal 803, and the accelerometer signal 805 for transmission to the electronic device 104.

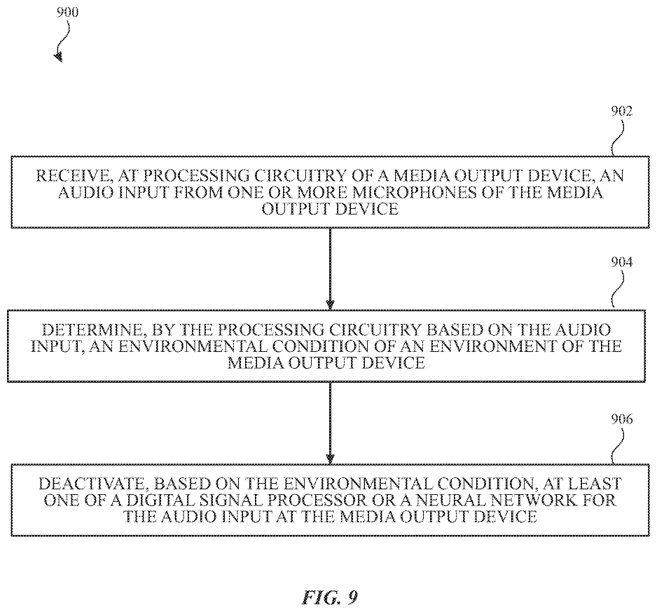

FIG. 9 illustrates a flow diagram of an example process 900 for environment-dependent audio processing at an audio device, in accordance with implementations of the subject technology. For explanatory purposes, the process 900 is primarily described herein with reference to the media output device 150 and electronic device 104 of FIGS. 1-3. However, the process 900 is not limited to the media output device 150 and electronic device 104 of FIGS. 1-3, and one or more blocks (or operations) of the process 900 may be performed by one or more other components of other suitable devices, including the electronic device 110, the electronic device 115, and/or the servers 120. Further for explanatory purposes, some of the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

As illustrated in FIG. 9, at block 902, processing circuitry (e.g., processing circuitry 306) of a media output device (e.g., media output device 150) may receive an audio input from one or more microphones (e.g., microphone(s) 152) of the media output device. As examples, the audio input may include the audio input 200, the audio input 210, or the audio input 212 of FIG. 2. The audio input may be received by the one or more microphones, and the one or more microphones may generate microphone signals responsive to the audio input.

At block 904, the processing circuitry (e.g., environmental condition detector 302) may determine, based on the audio input (e.g., based on the microphone signals generated by the one or more microphones responsive to the audio input), an environmental condition of an environment of the media output device. As examples, the environmental condition may include a speaker presence condition, a reverb condition, an indoor/outdoor condition, a wind presence condition, a noise condition such as an ambient noise presence condition, or any condition of a physical environment of the media output device that is detectable using one or more microphones.

At block 906, in one or more implementations, the processing circuitry (e.g., decision logic 400) may deactivate (e.g., switch off or bypass), based on the environmental condition, at least one of: a digital signal processor (DSP) or a neural network (e.g., one or more of the DSPs and/or neural networks 303) for the audio input at the media output device. In one or more other implementations, the processing circuitry may modify, based on the environmental condition, an operation of at least a portion of at least one of: a digital signal processor or a neural network for the audio input at the media output device (e.g., by switching off, ceasing operation of, and/or bypassing, a portion of or all of the digital signal processor or the neural network). Modifying at least a portion of the at least one of: the digital signal processor or the neural network for the audio input at the media output device may include operating the digital signal processor or the neural network in a course mode or a low power mode. As examples, the DSP or the neural network may include a source location beamformer, a multi-channel linear prediction block, a blind source separator, a de-noising block, a voice isolation block, a wind noise suppressor, or any other audio processing block or operation that may be implemented by a DSP or a trained neural network.

In one or more implementations, the environmental condition may include a reverb condition. In these implementations, the at least one of the digital signal processor or the neural network that is deactivated based on the reverb condition at block 906 may be configured to reduce a reverberation in the audio input. For example, the reverb condition may indicate a low reverberation condition of the physical environment of the media output device) and the reverb reducer (e.g., the multi-channel linear prediction block 702) may be deactivated.

In one or more implementations, the environmental condition may include an indoor/outdoor condition. In these implementations, the at least one of the digital signal processor or the neural network that is deactivated based on the indoor/outdoor condition at block 906 may be configured to reduce a reverberation in the audio input. For example, the indoor/outdoor condition may indicate that the media output device is in an outdoor environment (e.g., which would likely be a low reverberation environment), and the reverb reducer (e.g., the multi-channel linear prediction block 702) may be deactivated. As another example, the at least one of the digital signal processor or the neural network that is deactivated based on the indoor/outdoor condition at block 906 may be configured to remove wind noise from the audio input. For example, the indoor/outdoor condition may indicate that the media output device is in an indoor environment (e.g., which would likely be free of wind noise), and the wind noise suppressor (e.g., wind noise suppressor 710) may be deactivated.

In one or more implementations, the environmental condition may include a lack of a voice at a predetermined location. In these implementations, the at least one of the digital signal processor or the neural network that is deactivated at block 906 based on the lack of the voice (e.g., as indicated in a speaker presence condition indicator) may be configured to enhance a voice component of the audio input. For example, the speaker presence condition may indicate the lack of the voice, and the voice enhancer (e.g., voice isolation block 708, de-noising block 706, blind source separator 704, and/or source location beamformer 700) may be deactivated.

In one or more implementations, the process 900 may also include (e.g., by the processing circuitry of the media output device) determining an operational mode of the media output device (e.g., the earbud); and deactivating, based on the operational mode, at least one of: another digital signal processor or another neural network for the audio input. In one or more implementations, the processing circuitry of the media output device may also, or alternatively, deactivate one or more digital signal processors and/or neural networks based on the operational mode and independently of the environmental condition information. In one or more implementations, the process 900 may also include (e.g., by the processing circuitry of the media output device) receiving, from a companion device (e.g., electronic device 104), processing capability information for the companion device; and deactivating, based on the processing capability information for the companion device, at least one of: another digital signal processor or another neural network for the audio input. In one or more implementations, the processing circuitry of the media output device may also, or alternatively, deactivate one or more digital signal processors and/or neural networks based on the processing capability of the companion device and independently of the environmental condition information.

FIG. 10 illustrates a flow diagram of an example process 1000 for environment-dependent audio processing at a companion device of an audio device, in accordance with implementations of the subject technology. For explanatory purposes, the process 1000 is primarily described herein with reference to the media output device 150 and electronic device 104 of FIGS. 1-3. However, the process 1000 is not limited to the media output device 150 and electronic device 104 of FIGS. 1-3, and one or more blocks (or operations) of the process 1000 may be performed by one or more other components of other suitable devices, including the electronic device 110, the electronic device 115, and/or the servers 120. Further for explanatory purposes, some of the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

As illustrated in FIG. 10, at block 1002, an electronic device (e.g., electronic device 104, such as a companion device of a media output device) may receive audio information (e.g., encoded audio information) from a remote device (e.g., media output device 150). For example, the remote device may receive one or more audio inputs with one or more microphones of the remote device, generate microphone signals with the one or more microphones responsive to the one or more audio inputs, encode the microphone signals, and provide the encoded microphone signals to the electronic device as the audio information.

At block 1004, the audio information may be processed (e.g., at the electronic device) using at least one of: a digital signal processor or a neural network (e.g., one or more of DSPs and/or neural networks 304) at the electronic device. In one or more implementations, processing the audio information may include processing the audio information using the at least one of the digital signal processor or the neural network and using one or more additional digital signal processors or one or more additional neural networks.

At block 1006, the electronic device may provide processed audio information obtained from the digital signal processor or the neural network from the electronic device to the remote device. For example, the processed audio information may be provided to the remote device for output by one or more speakers of the remote device.

At block 1008, the electronic device may receive an environmental condition indicator at the electronic device from the remote device. As examples, the environmental condition indicator may include a speaker presence flag, a reverb flag, an indoor/outdoor flag, a wind presence flag, and/or an ambient noise flag. For example, the environmental condition indicator may indicate an environmental condition in a physical environment of the remote device as determined using an audio input corresponding to the audio information received from the remote device.

At block 1010, in one or more implementations, the electronic device may cease operation of the at least one of the digital signal processor or the neural network, responsive to receiving the environmental condition indicator. In one or more other implementations, the electronic device may modify, responsive to receiving the environmental condition indicator, an operation of at least a portion of at least one of: the digital signal processor or the neural network (e.g., by switching off, ceasing operation of, and/or bypassing, a portion of or all of the digital signal processor or the neural network). Modifying at least a portion of the at least one of the digital signal processor or the neural network may include operating the digital signal processor or the neural network in a course mode or a low power mode. As examples, the at least one of the digital signal processor or the neural network may include a source location beamformer, a multi-channel linear prediction block, a blind source separator, a de-noising block, a voice isolation block, and/or a wind noise suppressor.

At block 1012, the electronic device may provide, to the remote device, additional processed audio information generated from the audio information without using the at least one of the digital signal processor or the neural network. In one or more implementations, providing the additional processed audio information may include continuing to process the audio information using the one or more additional digital signal processors or the one or more additional neural networks while the operation of the at least one of the digital signal processor or the neural network is ceased.

In one or more implementations, the electronic device may also provide the additional processed audio information to another remote device. For example, the remote device may include an earbud, and the other remote device may be connected to a call (e.g., a telephone call, an audio conference, a video conference, or other group communication session) with the electronic device.

In one or more implementations, the environmental condition may include a reverb condition, and the at least one of the digital signal processor or the neural network may include a multi-channel linear prediction block. In one or more implementations, the environmental condition may include an indoor/outdoor condition, and the at least one of the digital signal processor or the neural network may include a multi-channel linear prediction block or a wind noise suppressor. In one or more implementations, the environmental condition may include a speaker presence condition and the at least one of the digital signal processor or the neural network may include a voice isolation block.

In one or more implementations, the audio information may include a first microphone signal (e.g., first microphone signal 801) corresponding to a first microphone at the remote device, the first microphone signal received as a first audio channel (e.g., a first audio channel 809) from the remote device; and a mixed signal (e.g., a mixed signal 807) that includes a second microphone signal (e.g., second microphone signal 803) and an accelerometer signal (e.g., sensor signal 805), the second microphone signal corresponding to a second microphone at the remote device, the accelerometer signal corresponding to an accelerometer (e.g., motion sensor 307) at the remote device, and the mixed signal received as a second audio channel (e.g., second audio channel 811), in parallel with receiving the first microphone signal as the first audio channel, from the remote device. The processed audio information and/or the additional processed audio information may each be based, at least in part, on the first microphone signal, the second microphone signal, and the accelerometer signal.

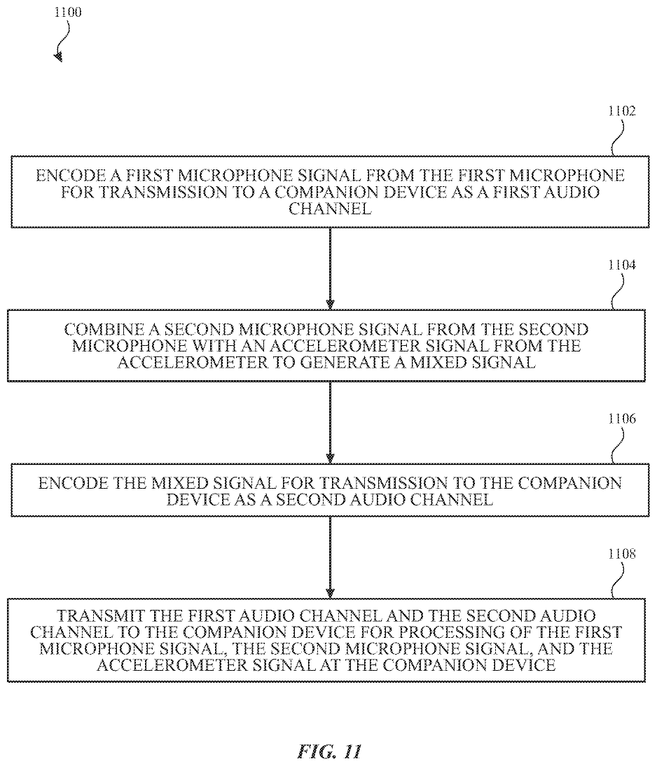

FIG. 11 illustrates a flow diagram of an example process 1100 for audio processing by a media output device, in accordance with implementations of the subject technology. For explanatory purposes, the process 1100 is primarily described herein with reference to the media output device 150 and electronic device 104 of FIGS. 1-3. However, the process 1100 is not limited to the media output device 150 and electronic device 104 of FIGS. 1-3, and one or more blocks (or operations) of the process 1100 may be performed by one or more other components of other suitable devices, including the electronic device 110, the electronic device 115, and/or the servers 120. Further for explanatory purposes, some of the blocks of the process 1100 are described herein as occurring in serial, or linearly. However, multiple blocks of the process 1100 may occur in parallel. In addition, the blocks of the process 1100 need not be performed in the order shown and/or one or more blocks of the process 1100 need not be performed and/or can be replaced by other operations.

As illustrated in FIG. 11, at block 1102, a first microphone signal (e.g., first microphone signal 801) from a first microphone (e.g., a microphone 152 of a media output device 150 having first and second microphones 152, a speaker 151, a motion sensor 307, such as an accelerometer, and processing circuitry 306) may be encoded (e.g., by encoder 502 of the media output device 150) for transmission to a companion device (e.g., electronic device 104) as a first audio channel (e.g., first audio channel 809).

At block 1104, a second microphone signal (e.g., second microphone signal 803) from the second microphone may be combined (e.g., by the mixer 821 of the media output device 150) with an accelerometer signal (e.g., sensor signal 805) from the accelerometer to generate a mixed signal (e.g., mixed signal 807). For example, the first microphone may be configured to generate the first microphone signal responsive to an audio input (e.g., audio input 200, audio input 210, audio input 212, audio input 214, and/or audio input 215), and the second microphone may be configured to generate the second microphone signal responsive to the audio input. The accelerometer may be configured to generate the accelerometer signal based on the audio input.

At block 1106, the mixed signal may be encoded (e.g., by encoder 502 of the media output device 150) for transmission to the companion device as a second audio channel (e.g., second audio channel 811).

At block 1108, the first audio channel and the second audio channel may be transmitted from the media output device to the companion device for processing of the first microphone signal, the second microphone signal, and the accelerometer signal at the companion device.

In one or more implementations, the audio input (e.g., audio input 215) may include a voice of a user (e.g., user 101) of the media output device, and transmitting the first audio channel and the second audio channel to the companion device for processing of the first microphone signal, the second microphone signal, and the accelerometer signal at the companion device may include transmitting the first audio channel and the second audio channel to the companion device for processing of the first microphone signal, the second microphone signal, and the accelerometer signal at the companion device to generate processed uplink audio comprising at least a portion of the voice of the user.

In one or more implementations, the media output device may also include one or more additional microphones, and the process 1100 may also include transmitting one or more additional microphone signals from the one or more additional microphones to the companion device for processing, at the companion device, with the first microphone signal, the second microphone signal, and the accelerometer signal. In one or more implementations, the media output device may also include one or more additional accelerometers, and the process 1100 may also include transmitting one or more additional accelerometers signals from the one or more additional accelerometers to the companion device for processing, at the companion device, with the first microphone signal, the second microphone signal, and the accelerometer signal.

In one or more implementations, the process 1100 may also include providing (e.g., by the processing circuitry 306 of the media output device) operational mode information to the companion device. The operational mode information may indicate a current operational mode of the media output device. In one or more implementations, the companion device may generate processed audio based on the first microphone signal, the second microphone signal, and the accelerometer signal and according to the current operational mode.

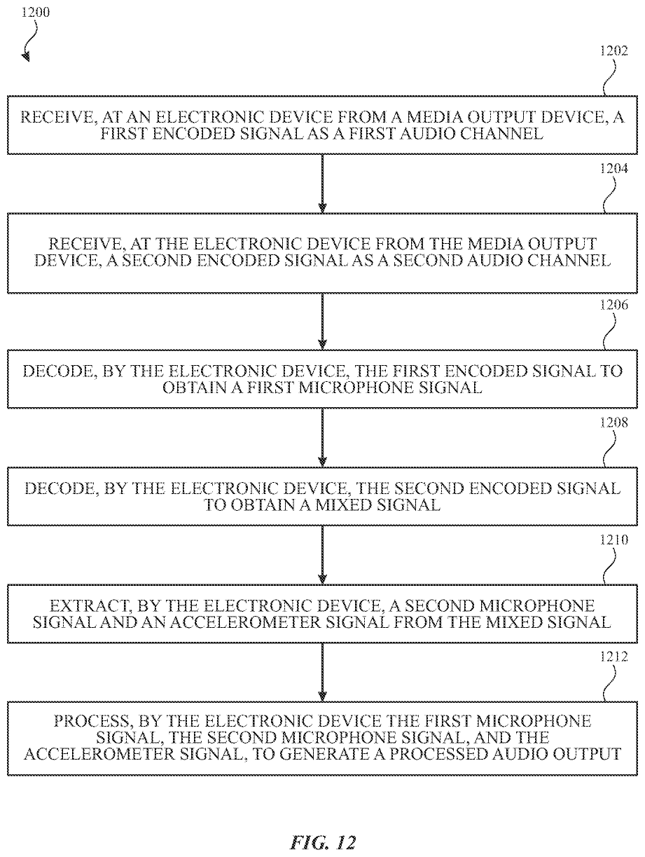

FIG. 12 illustrates a flow diagram of an example process 1200 for audio processing at a companion device, in accordance with implementations of the subject technology. For explanatory purposes, the process 1200 is primarily described herein with reference to the media output device 150 and electronic device 104 of FIGS. 1-3. However, the process 1200 is not limited to the media output device 150 and electronic device 104 of FIGS. 1-3, and one or more blocks (or operations) of the process 1200 may be performed by one or more other components of other suitable devices, including the electronic device 110, the electronic device 115, and/or the servers 120. Further for explanatory purposes, some of the blocks of the process 1200 are described herein as occurring in serial, or linearly. However, multiple blocks of the process 1200 may occur in parallel. In addition, the blocks of the process 1200 need not be performed in the order shown and/or one or more blocks of the process 1200 need not be performed and/or can be replaced by other operations.

As illustrated in FIG. 12, at block 1202, a first encoded signal may be received (e.g., at an electronic device, such as the electronic device 104, from a media output device, such as the media output device 150) as a first audio channel (e.g., first audio channel 809, or Ch1 as in FIG. 8).

At block 1204, a second encoded signal may be received (e.g., at the electronic device, such as the electronic device 104, from the media output device, such as the media output device 150) as a second audio channel (e.g., second audio channel 811, or Ch2 as in FIG. 8). The first encoded signal and the second encoded signal may be received in parallel (e.g., concurrently) at the electronic device from the media output device.

At block 1206, the first encoded signal may be decoded (e.g., by the decoder 802 of the electronic device 104) to obtain a first microphone signal (e.g., first microphone signal 801).

At block 1208, the second encoded signal may be decoded (e.g., by decoder 802 the electronic device 104) to obtain a mixed signal (e.g., mixed signal 807). For example, the mixed signal may include at least some of the second microphone signal 803 and at least some of the sensor signal 805, as described herein in connection with FIG. 8.

At block 1210, at least a second microphone signal (e.g., second microphone signal 803) and an accelerometer signal (e.g., sensor signal 805) may be extracted or reconstructed (e.g., by the microphone reconstruction block 806 and the accelerometer reconstruction block 808 of the electronic device 104) from the mixed signal.

At block 1212, the first microphone signal, the second microphone signal, and the accelerometer signal may be processed (e.g., by DSPs and/or neural networks 304) to generate a processed audio output (e.g., processed audio 813, as described in connection with FIG. 8). For example, the processed audio output may include processed uplink audio for transmission (e.g., from the electronic device) to a remote device.

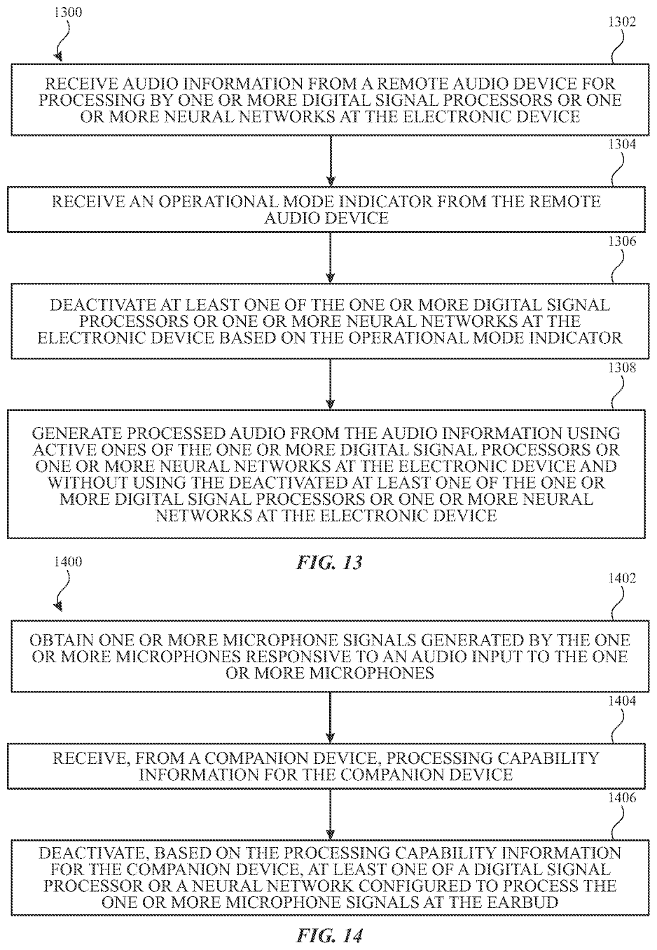

FIG. 13 illustrates a flow diagram of an example process 1300 for audio processing at an electronic device, in accordance with implementations of the subject technology. For explanatory purposes, the process 1300 is primarily described herein with reference to the media output device 150 and electronic device 104 of FIGS. 1-3. However, the process 1300 is not limited to the media output device 150 and electronic device 104 of FIGS. 1-3, and one or more blocks (or operations) of the process 1300 may be performed by one or more other components of other suitable devices, including the electronic device 110, the electronic device 115, and/or the servers 120. Further for explanatory purposes, some of the blocks of the process 1300 are described herein as occurring in serial, or linearly. However, multiple blocks of the process 1300 may occur in parallel. In addition, the blocks of the process 1300 need not be performed in the order shown and/or one or more blocks of the process 1300 need not be performed and/or can be replaced by other operations.

As illustrated in FIG. 13, at block 1302, audio information may be received by an electronic device (e.g., the electronic device 104) from a media output device (e.g., media output device 150) for processing by one or more digital signal processors or one or more neural networks (e.g., DSPs and/or neural networks 304) at the electronic device.

At block 1304, the electronic device may receive an operational mode indicator from the media output device. For example, the media output device may be implemented as headphones or one or more earbuds. The operational mode indicator may include an indication of a current operational mode of the media output device.

At block 1306, the electronic device may deactivate at least one of the one or more digital signal processors or one or more neural networks at the electronic device based on the operational mode indicator. As examples, the one or more digital signal processors or one or more neural networks may include a source location beamformer, an echo canceller, a multi-channel linear prediction block, a blind source separator, a multi-microphone filter, a generalized sidelobe canceller, a de-noising block, a voice isolation block, or a wind noise suppressor, and/or all of which may be implemented as a DSP or a neural network.

At block 1308, the electronic device may generate processed audio (e.g., processed audio 813) from the audio information using active ones of the one or more digital signal processors or one or more neural networks at the electronic device, and without using the deactivated at least one of the one or more digital signal processors or one or more neural networks at the electronic device. In one or more implementations, the processed audio may include processed local audio, and process 1300 may also include providing the processed local audio to the media output device for output by a speaker of the media output device.

In one or more implementations, the electronic device may provide the processed audio to the media output device for output by a speaker of the media output device. In this way, the electronic device can process audio received at the media output device, based on an operational mode of the media output device. In one or more implementations, the processed audio may include processed uplink audio, and the electronic device may also provide the processed uplink audio (e.g., in an uplink signal) to a remote device (e.g., electronic device 110, electronic device 115, or another electronic device) that is connected to a call with the electronic device.

In one or more use cases, the operational mode indicator may indicate that the media output device is in a hearing assistance mode of operation and the active ones of the one or more digital signal processors or one or more neural networks at the electronic device may include a voice isolation block. In one or more other use cases, the operational mode indicator may indicate that the media output device is in a media playback mode of operation and the deactivated at least one of the one or more digital signal processors or one or more neural networks at the electronic device may include a beamformer. In one or more other use cases, the operational mode indicator may indicate that the media output device is in a noise cancellation mode of operation and the deactivated at least one of the one or more digital signal processors or one or more neural networks at the electronic device may include a beamformer and a voice isolation block.

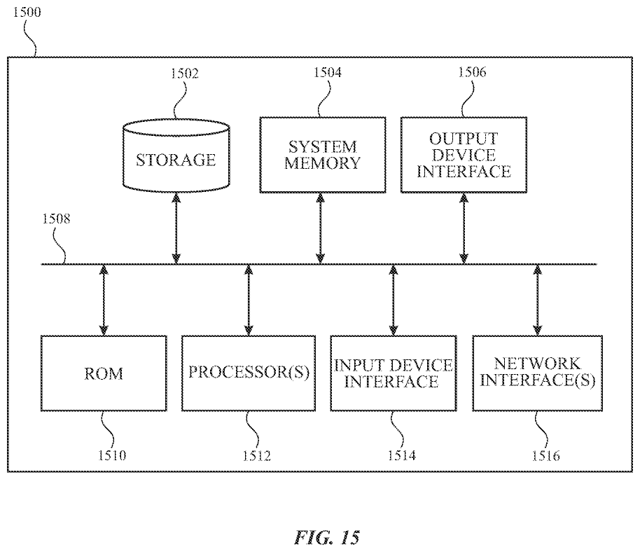

FIG. 14 illustrates a flow diagram of an example process 1400 for audio processing at a media output device such as an earbud, in accordance with implementations of the subject technology. For explanatory purposes, the process 1400 is primarily described herein with reference to the media output device 150 and electronic device 104 of FIGS. 1-3. However, the process 1400 is not limited to the media output device 150 and electronic device 104 of FIGS. 1-3, and one or more blocks (or operations) of the process 1400 may be performed by one or more other components of other suitable devices, including the electronic device 110, the electronic device 115, and/or the servers 120. Further for explanatory purposes, some of the blocks of the process 1400 are described herein as occurring in serial, or linearly. However, multiple blocks of the process 1400 may occur in parallel. In addition, the blocks of the process 1400 need not be performed in the order shown and/or one or more blocks of the process 1400 need not be performed and/or can be replaced by other operations.

As illustrated in FIG. 14, at block 1402, one or more microphone signals (e.g., first microphone signal 801 and/or second microphone signal 803) generated by the one or more microphones responsive to an audio input to the one or more microphones may be obtained (e.g., by processing circuitry such as processing circuitry 306 of an earbud, such as media output device 150).

At block 1404, processing capability information for a companion device (e.g., electronic device 104) may be received from the companion device (e.g., at the media output device, such as at the earbud). As examples, the processing capability information may include processor capabilities, memory availability, software version number(s), and/or indications of one or more DSPs and/or neural networks that are available at the companion device.

At block 1406, based on the processing capability information for the companion device, at least one of a digital signal processor or a neural network configured to process the one or more microphone signals at the media output device (e.g., earbud) may be deactivated (e.g., by the earbud). For example, the processing capability information for the companion device may indicate that the at least one of the digital signal processor or the neural network is available at the companion device (e.g., and can therefore be executed for processing of the microphone signals at the companion device, rather than at the earbud).

In one or more implementations, the process 1400 may also include providing the one or more microphone signals from the one or more microphones to the companion device for processing by the at least one of the digital signal processor or the neural network that is available at the companion device; and receiving, from the companion device for output (e.g., by a speaker 151 of the earbud), processed audio (e.g., processed audio 813) that has been generated by the companion device based on the one or more microphone signals using the at least one of the digital signal processor or the neural network that is available at the companion device.

In one or more implementations, the process 1400 may also include providing a sensor signal (e.g., sensor signal 805), generated by a motion sensor (e.g., motion sensor 307) of the media output device (e.g., earbud), to the companion device. The processed audio received from the companion device may be based at least in part on the sensor signal. For example, the motion sensor may include an accelerometer, and the sensor signal may include an accelerometer signal.

In one or more implementations, the one or more microphones may include a first microphone (e.g., a first microphone 152, such as a top microphone) and a second microphone (e.g., a second microphone 152, such as a bottom microphone), and providing the one or more microphone signals to the companion device may include providing a first microphone signal (e.g., first microphone signal 801) from the first microphone to the companion device as a first audio channel (e.g., first audio channel 809); and providing a mixed signal (e.g., mixed signal 807), the mixed signal including a second microphone signal (e.g., second microphone signal 803) from the second microphone and the sensor signal (e.g., sensor signal 805), to the companion device as a second audio channel (e.g., second audio channel 811), such as in parallel with or concurrently with providing the first microphone signal over the first audio channel.

As described above, one aspect of the present technology is the gathering and use of data available from specific and legitimate sources for environment-based audio processing for audio devices. The present disclosure contemplates that in some instances, this gathered data may include personal information data that uniquely identifies or can be used to identify a specific person. Such personal information data can include audio data, voice samples, voice profiles, demographic data, location-based data, online identifiers, telephone numbers, email addresses, home addresses, biometric data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for environment-based audio processing for audio devices.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the example of environment-based audio processing for audio devices, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 15 illustrates an electronic system 1500 with which one or more implementations of the subject technology may be implemented. The electronic system 1500 can be, and/or can be a part of, the media output device 150, the electronic device 104, the electronic device 110, the electronic device 115, and/or the server 120 as shown in FIG. 1. The electronic system 1500 may include various types of computer readable media and interfaces for various other types of computer readable media. The electronic system 1500 includes a bus 1508, one or more processing unit(s) 1512, a system memory 1504 (and/or buffer), a ROM 1510, a permanent storage device 1502, an input device interface 1514, an output device interface 1506, and one or more network interfaces 1516, or subsets and variations thereof.

The bus 1508 collectively represents all system, peripheral, and chipset buses that communicatively connect the numerous internal devices of the electronic system 1500. In one or more implementations, the bus 1508 communicatively connects the one or more processing unit(s) 1512 with the ROM 1510, the system memory 1504, and the permanent storage device 1502. From these various memory units, the one or more processing unit(s) 1512 retrieves instructions to execute and data to process in order to execute the processes of the subject disclosure. The one or more processing unit(s) 1512 can be a single processor or a multi-core processor in different implementations.

The ROM 1510 stores static data and instructions that are needed by the one or more processing unit(s) 1512 and other modules of the electronic system 1500. The permanent storage device 1502, on the other hand, may be a read-and-write memory device. The permanent storage device 1502 may be a non-volatile memory unit that stores instructions and data even when the electronic system 1500 is off. In one or more implementations, a mass-storage device (such as a magnetic or optical disk and its corresponding disk drive) may be used as the permanent storage device 1502.

In one or more implementations, a removable storage device (such as a floppy disk, flash drive, and its corresponding disk drive) may be used as the permanent storage device 1502. Like the permanent storage device 1502, the system memory 1504 may be a read-and-write memory device. However, unlike the permanent storage device 1502, the system memory 1504 may be a volatile read-and-write memory, such as random access memory. The system memory 1504 may store any of the instructions and data that one or more processing unit(s) 1512 may need at runtime. In one or more implementations, the processes of the subject disclosure are stored in the system memory 1504, the permanent storage device 1502, and/or the ROM 1510 (which are each implemented as a non-transitory computer-readable medium). From these various memory units, the one or more processing unit(s) 1512 retrieves instructions to execute and data to process in order to execute the processes of one or more implementations.

The bus 1508 also connects to the input and output device interfaces 1514 and 1506. The input device interface 1514 enables a user to communicate information and select commands to the electronic system 1500. Input devices that may be used with the input device interface 1514 may include, for example, alphanumeric keyboards and pointing devices (also called “cursor control devices”). The output device interface 1506 may enable, for example, the display of images generated by electronic system 1500. Output devices that may be used with the output device interface 1506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 15, the bus 1508 also couples the electronic system 1500 to one or more networks and/or to one or more network nodes, such as the electronic device 104 shown in FIG. 1, through the one or more network interface(s) 1516. In this manner, the electronic system 1500 can be a part of a network of computers (such as a LAN, a wide area network (“WAN”), or an Intranet, or a network of networks, such as the Internet. Any or all components of the electronic system 1500 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

In accordance with aspects of the disclosure, a method is provided that includes receiving, at processing circuitry of a media output device, an audio input from one or more microphones of the media output device; determining, by the processing circuitry based on the audio input, an environmental condition of an environment of the media output device; and deactivating, based on the environmental condition, at least one of: a digital signal processor or a neural network for the audio input at the media output device.

In accordance with aspects of the disclosure, an electronic device is provided that includes a memory; and one or more processors configured to: receive audio information from a remote device; process the audio information using at least one of: a digital signal processor or a neural network at the electronic device; provide processed audio information obtained from the at least one of the digital signal processor or the neural network to the remote device; receive an environmental condition indicator from the remote device; cease operating the at least one of the digital signal processor or the neural network, responsive to receiving the environmental condition indicator; and provide additional processed audio information, generated from the audio information without using the at least one of the digital signal processor or the neural network, to the remote device.

In accordance with aspects of the disclosure, an earbud is provided that includes one or more microphones; and processing circuitry configured to: receive an audio input from the one or more microphones; determine, based on the audio input, an environmental condition of an environment of the earbud; and deactivate, based on the environmental condition, at least one of: a digital signal processor or a neural network for the audio input.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

What is claimed is:

1. A media output device, comprising:
a first microphone;
a second microphone;
an accelerometer;
a speaker; and
processing circuitry configured to:
encode a first microphone signal from the first microphone for transmission to a companion device as a first audio channel;
combine a second microphone signal from the second microphone with an accelerometer signal from the accelerometer to generate a mixed signal;
encode the mixed signal for transmission to the companion device as a second audio channel; and
transmit the first audio channel and the second audio channel to the companion device for processing of the first microphone signal, the second microphone signal, and the accelerometer signal at the companion device.

2. The media output device of claim 1, wherein the first microphone is configured to generate the first microphone signal responsive to an audio input, and the second microphone is configured to generate the second microphone signal responsive to the audio input.

3. The media output device of claim 2, wherein the media output device further comprises one or more additional microphones, and wherein the processing circuitry is configured to transmit one or more additional microphone signals from the one or more additional microphones to the companion device for processing, at the companion device, with the first microphone signal, the second microphone signal, and the accelerometer signal.

4. The media output device of claim 3, wherein the media output device further comprises one or more additional accelerometers, and wherein the processing circuitry is configured to transmit one or more additional accelerometers signals from the one or more additional accelerometers to the companion device for processing, at the companion device, with the first microphone signal, the second microphone signal, and the accelerometer signal.

5. The media output device of claim 2, wherein the accelerometer is configured to generate the accelerometer signal based on the audio input.

6. The media output device of claim 5, wherein the audio input comprises a voice of a user of the media output device, and wherein the media output device is configured to transmit the first audio channel and the second audio channel to the companion device for processing of the first microphone signal, the second microphone signal, and the accelerometer signal at the companion device to generate processed uplink audio comprising at least a portion of the voice of the user.

7. The media output device of claim 1, wherein the processing circuitry is further configured to provide operational mode information to the companion device, the operational mode information indicating a current operational mode of the media output device.

8. An electronic device, comprising:
a memory; and
one or more processors configured to:
receive audio information wirelessly from a media output device for processing by one or more digital signal processors or one or more neural networks at the electronic device;
receive an operational mode indicator from the media output device;
deactivate at least one of the one or more digital signal processors or one or more neural networks at the electronic device based on the operational mode indicator; and
generate processed audio from the audio information using active ones of the one or more digital signal processors or one or more neural networks at the electronic device and without using the deactivated at least one of the one or more digital signal processors or one or more neural networks at the electronic device.

9. The electronic device of claim 8, wherein the media output device comprises headphones or an earbud, wherein the processed audio comprises processed local audio, and wherein the one or more processors are further configured to provide the processed local audio to the media output device for output by a speaker of the media output device.

10. The electronic device of claim 8, wherein the operational mode indicator indicates that the media output device is in a hearing assistance mode of operation and wherein the active ones of the one or more digital signal processors or one or more neural networks at the electronic device comprise a voice isolation block.

11. The electronic device of claim 8, wherein the operational mode indicator indicates that the media output device is in a media playback mode of operation and wherein the deactivated at least one of the one or more digital signal processors or one or more neural networks at the electronic device comprises a beamformer.

12. The electronic device of claim 8, wherein the operational mode indicator indicates that the media output device is in a noise cancellation mode of operation and wherein the deactivated at least one of the one or more digital signal processors or one or more neural networks at the electronic device comprises a beamformer and a voice isolation block.

13. The electronic device of claim 8, wherein the one or more digital signal processors or one or more neural networks comprise a source location beamformer, an echo canceller, a multi-channel linear prediction block, a blind source separator, a multi-microphone filter, a generalized sidelobe canceller, a de-noising block, a voice isolation block, or a wind noise suppressor.

14. The electronic device of claim 8, wherein the processed audio comprises processed uplink audio, and wherein the one or more processors are further configured to provide the processed uplink audio to a remote device that is connected to a call with the electronic device.

15. A media output device, comprising:
one or more microphones; and
processing circuitry configured to:
obtain one or more microphone signals generated by the one or more microphones responsive to an audio input to the one or more microphones;
receive, from a companion device, processing capability information for the companion device; and
deactivate, based on the processing capability information for the companion device, at least one of a digital signal processor or a neural network configured to process the one or more microphone signals at the media output device.

16. The media output device of claim 15, wherein the processing capability information for the companion device indicates that the at least one of the digital signal processor or the neural network is available at the companion device.

17. The media output device of claim 16, wherein the processing circuitry is further configured to:
provide the one or more microphone signals from the one or more microphones to the companion device for processing by the at least one of the digital signal processor or the neural network that is available at the companion device; and
receive, from the companion device for output by a speaker of the media output device, processed audio that has been generated by the companion device based on the one or more microphone signals using the at least one of the digital signal processor or the neural network that is available at the companion device.

18. The media output device of claim 17, wherein the processing circuitry is further configured to:
provide a sensor signal, generated by a motion sensor of the media output device, to the companion device, wherein the processed audio received from the companion device is based at least in part on the sensor signal.

19. The media output device of claim 18, wherein the motion sensor comprises an accelerometer, and wherein the sensor signal comprises an accelerometer signal.

20. The media output device of claim 18, wherein the one or more microphones comprise at least a first microphone and a second microphone, and wherein the processing circuitry is configured to provide the one or more microphone signals to the companion device by:
providing a first microphone signal from the first microphone to the companion device as a first audio channel; and
providing a mixed signal, the mixed signal including a second microphone signal from the second microphone and the sensor signal to the companion device, to the companion device as a second audio channel.
